(19) United States
(12) Patent Application Publication
(10) Pub. No.: US 2026/0175388 A1
(43) Pub. Date: Jun. 25, 2026

(54) DRIVING TOOL

(71) Applicant: MAKITA CORPORATION, Anjo-shi (JP)

(72) Inventors: Makito TERAMOTO, Anjo-shi (JP); Kiyonobu YOSHIKANE, Anjo-shi (JP)

(73) Assignee: MAKITA CORPORATION, Anjo-shi (JP)

(21) Appl. No.: 19/395,418

(22) Filed: Nov. 20, 2025

(30) Foreign Application Priority Data
Dec. 24, 2024 (JP) 2024-227206
Dec. 24, 2024 (JP) 2024-227228

(51) Int. Cl. B25C 5/15; B25C 5/13; B25C 5/16

(52) U.S. Cl. CPC B25C 5/15; B25C 5/13; B25C 5/1606

(57) ABSTRACT

A driving tool has a driving mechanism, a power transmission mechanism, and a mechanism housing. The driving mechanism biases a driver forward. The power transmission mechanism moves the driver rearward using an output from an electric motor. The mechanism housing houses the power transmission mechanism. The driving tool has a motor housing, a fastening portion, and a main body housing. The motor housing houses the electric motor. The fastening portion fastens the motor housing to the mechanism housing with screws. The main body housing is configured to cover the mechanism housing, while leaving the motor housing exposed.

### CROSS-REFERENCE TO RELATED APPLICATION

This application claims priority to Japanese patent application serial number 2024-227206, filed on Dec. 24, 2024, and to Japanese patent application serial number 2024-227228, filed on Dec. 24, 2024, the contents of which are incorporated herein by reference in their entirety for all purposes.

### TECHNICAL FIELD

The present invention generally relates to a driving tool for driving a driving member into a workpiece.

### BACKGROUND

For example, a so-called gas spring type driving tool is well-known. The gas spring type driving tool has a driver, a driving mechanism, an electric motor, and a lifter. The driver moves in a driving direction by the driving mechanism and moves in a direction opposite to the driving direction by the lifter. The driving mechanism has a cylinder that extends in the driving direction and a piston that is movable within the cylinder and formed integrally with the driver. The lifter is driven by the output of the electric motor transmitted through a reduction gear, a planetary reduction mechanism, or other transmission components. When the lifter is driven to move the driver and the piston in the direction opposite to the driving direction, the gas pressure in the accumulation chamber, which is above the piston, increases. The driver moves in the driving direction using this gas pressure as a driving force. A driving member is sequentially supplied from a magazine to a driving passage in front of the driver in the driving direction. The driving member is driven into the workpiece by the driver that moves in the driving direction.

The mechanism driven by the transmission of the output of the electric motor, such as the reduction gear and the lifter, and the driving mechanism in which driving energy is accumulated by rotation of the lifter are both housed in an integrally connected mechanism housing. In addition, bearings that rotatably support a motor shaft of the electric motor are press-fitted into the mechanism housing. Therefore, the motor shaft and a rotor formed integrally with the motor shaft are supported by the mechanism housing. On the other hand, a stator of the electric motor is fixed in a motor housing separate from the mechanism housing. In conventional products, the motor housing is connected to the mechanism housing by joining structures including spigot-type configurations and similar fitting mechanism. The driving tool is provided with a main body housing that covers the mechanism housing and the motor housing from the outside. The mechanism housing and the motor housing are positioned relative to each other by being accommodated in the main body housing. That is, the motor housing is positioned without being fixed to the mechanism housing by fastening or the like.

The piston of the driving mechanism slides inside the cylinder during the driving operation and collides with a damper at the bottom dead center. The driver collides with the driving member during the driving operation, and receives a reaction force from the workpiece via the driving member. Vibrations caused by these sliding, collisions, reaction forces, etc. are transmitted to the mechanism housing. The vibration is also transmitted to the motor shaft and the rotor supported by the mechanism housing. On the other hand, since the stator and the motor housing are not fixed to the mechanism housing, the stator and the motor housing do not follow the vibration generated in the mechanism housing. Therefore, when the vibration occurs on the mechanism housing side, there is a possibility that the rotor and the stator may come into contact, resulting in core rubbing. Thus, there was room for improvement in the driving tool to suppress the core rubbing of the electric motor.

In addition, in driving tools in the prior art, the electric motor is disposed between the magazine and the handle in the driving direction. Specifically, the electric motor is disposed forward of an operating surface of the trigger provided on the handle in the driving direction and rearward of a rear end of the magazine in the driving direction. In other words, the magazine and the drive mechanism, including the electric motor, account for most of the tool's weight. Therefore, a center of gravity of the tool is located near an ejection port, which is far from the handle. Consequently, when a user holds the handle to use the driving tool, an unbalanced center of gravity may affect ease of handling.

By way of example, one may consider a configuration in which a driving tool, known as a fencing stapler, is provided utilizing a gas spring mechanism. This type of driving tool drives staples into wooden posts that stand upright. In this case, when the staple is driven, a metal wire used in fence construction is inserted between a pair of legs of the staple, thereby retaining the wire to the post together with the driven staple. By securing each of the multiple wires, which form the fence, to the posts, the fence is attached to the posts.

The staples are driven approximately horizontally into the standing posts. Therefore, the fencing stapler is used in a posture in which, for example, the handle and the magazine extend downward from the tool main body. Alternatively, the fencing stapler is used in a posture in which the handle and the magazine extend approximately horizontally direction (lateral orientation). When the center of gravity of the product is located near the ejection port, which is far from the handle, there is a risk that the area near the ejection port will tilt downward (wobble) during the ejection of the driving member. Consequently, the user gripping the handle may experience discomfort due to the unbalanced center of gravity. The imbalance in the center of gravity becomes more noticeable, especially when the tool is used in the lateral orientation. Accordingly, the tool may suffer from reduced handling (maneuverability), and there remains potential for improvement in the balance of its center of gravity.

### SUMMARY

Thus, there is a need for a driving tool that can prevent core friction by reduced contact between the rotor and the stator in the electric motor.

In addition, there is a need for a driving tool with improved handling (maneuverability), which is achieved by positioning the handle closer to the tool's center of gravity.

According to one feature of the present invention, the driving tool has a driving mechanism, a power transmission mechanism, and a mechanism housing. The driving mechanism biases a driver forward. The power transmission mechanism moves the driver rearward by the output of the electric motor. The mechanism housing houses the power transmission mechanism. The driving tool has a motor housing, a fastening portion, and a main body housing. The motor housing houses the electric motor. The fastening portion fastens the motor housing to the mechanism housing with screws (fasteners). The main body housing is configured to enclose the mechanism housing, while leaving the motor housing exposed.

Therefore, the mechanism housing, which rotatably supports the motor shaft and the rotor, and the motor housing, which supports the stator, are fastened with screws (fasteners). Accordingly, the motor housing is configured to follow the vibration generated by the power transmission mechanism inside the mechanism housing. More specifically, the vibration transmitted from the mechanism housing to the rotor and the vibration transmitted from the mechanism housing to the stator via the motor housing occur in the same vibration mode. This mechanism mitigates contact between the rotor and the stator by vibration transmission. Accordingly, contact between the rotor and the stator of the electric motor is effectively suppressed, thereby preventing core rubbing.

In addition, by exposing the motor housing from the main body housing, the size of the area surrounding the motor housing can be reduced. As a result, the design flexibility of structures near the motor housing, such as the magazine and handle, is enhanced, enabling a more compact configuration of the entire driving tool.

### BRIEF DESCRIPTION OF DRAWING

FIG. 1 is a perspective view of a driving tool according to the present disclosure, which is viewed from the upper left front.

FIG. 2 is a left side view of the driving tool.

FIG. 3 is a left side view of the driving tool, showing a pusher is lowered and held in place.

FIG. 4 is a front view of the driving tool.

FIG. 5 is a cross-sectional view taken along line V-V of FIG. 2.

FIG. 6 is a cross-sectional view taken along line VI-VI of FIG. 2.

FIG. 7 is a cross-sectional view taken along line VII-VII of FIG. 6, showing a driver has moved to a bottom dead center.

FIG. 8 is a similar view as FIG. 7, showing the driver is at a standby position.

FIG. 9 is a perspective view of the driving tool, which is viewed from the lower left front.

FIG. 10 is a cross-sectional view taken along line X-X of FIG. 2.

FIG. 11 is a right side view of the driving tool.

FIG. 12 is a right side view of the driving tool without a right housing

FIG. 13 is an exploded perspective view illustrating a mechanism unit, a motor housing, and a main body housing in a disassembled state.

FIG. 14 is a perspective view of a speed reduction mechanism.

FIG. 15 is an exploded perspective view of a stopper.

FIG. 16 is a cross-sectional view taken along line XVI-XVI of FIG. 5, showing a state where an inner ring rotates in a forward direction.

FIG. 17 is a similar view as FIG. 16, showing a state where the inner ring rotates in a reverse direction.

FIG. 18 is an exploded perspective view of a buffering mechanism, which is viewed from the upper left front.

FIG. 19 is an exploded perspective view of the buffering mechanism, which is viewed from the upper right front.

FIG. 20 is a cross-sectional view taken along line XX-XX of FIG. 6.

### DETAILED DESCRIPTION

The detailed description set forth below, when considered with the appended drawings, is intended to be a description of exemplary embodiments of the present disclosure and is not intended to be restrictive and/or representative of the only embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the disclosure. It will be apparent to those skilled in the art that the exemplary embodiments of the disclosure may be practiced without these specific details. In some instances, these specific details refer to well-known structures, components, and/or devices that are shown in block diagram form in order to avoid obscuring significant aspects of the exemplary embodiments presented herein.

According to other features of the present disclosure, the motor housing is formed in a tubular shape. A tubular fastened portion of the mechanism housing, to which a fastening portion is fastened with screws (fasteners), is exposed (away) from the main body housing. Therefore, vibration can be more effectively suppressed from being transmitted from the mechanism housing to the motor housing via the main body housing. In addition, the compactness around the motor housing can be further improved. Furthermore, by fastening the tubular motor housing to the tubular fastened portion, the overall structure can be made more compact while maintaining the airtightness and rigidity between the motor housing and the mechanism housing at levels comparable to the conventional designs.

According to other features of the present disclosure, the main body housing has an upper housing, a handle housing, and a lower housing. The upper housing houses the mechanism housing. The handle housing extends downward from the upper housing and supports the handle. The lower housing protrudes forward from the lower portion of the handle housing and connects to the lower portion of the motor housing.

For example, a case is considered where vibration is transmitted from the mechanism housing to the lower portion of the motor housing via the main body housing. The transmission path of the vibration involves the upper housing, the handle housing, and the lower housing. The main body housing is made of a material with lower rigidity than the motor housing. If vibration is transmitted through this transmission path, the handle housing mainly deflects. Therefore, the vibration is reduced before transmitted to the lower housing. As a result, vibration transmitted to the motor housing via the main body housing can be effectively suppressed. Accordingly, vibration transmitted to the motor housing from components other than the mechanism housing can be effectively suppressed. As a result, the vibration modes of the rotor and stator can be better aligned, thereby suppressing core rubbing.

According to other features of the present disclosure, an elastic member is placed between the upper housing and the mechanism housing. Therefore, by absorbing vibration with the elastic member, vibration transmitted from the mechanism housing to the upper housing can be efficiently reduced.

According to another feature of the present disclosure, the elastic member is a rubber ring that is held in an elastically deformed state between the outer surface of the mechanism housing and the inner surface of the upper housing. Therefore, the mechanism housing and the upper housing are connected with the rubber ring clamped between them over a wide range corresponding to the diameter of the rubber ring. As a result, the vibration transmitted from the mechanism housing to the main body housing can be effectively reduced while improving the stability with which the main body housing holds the mechanism housing.

According to other features of the present disclosure, the lower housing has a connecting portion. The connecting portion connects to the lower portion of the motor housing and positions the lower portion of the motor housing. Therefore, the lower portion of the motor housing and the connecting portion of the lower housing are connected and positioned relative to each other without placing, for example, an elastic member. Therefore, the motor housing is fastened to the mechanism housing with screws (fasteners) at the upper portion and positioned in the up-down direction. As a result, the motor housing can be held in a stable manner.

According to other features of the present disclosure, a controller that controls the electric motor is provided. The controller is housed in the lower housing. Therefore, by arranging the controller in the vicinity of the electric motor, wirings connecting the controller and the motor can be made compact. Moreover, the controller can be compactly arranged by utilizing the space below the electric motor.

According to another feature of the present invention, the driving tool has a fan, a ventilation hole, and an air passage. The fan rotates by driving of the electric motor. The ventilation hole is disposed in the lower portion of the lower housing. The air passage introduces outside air, taken in by the suction force of the fan from the ventilation hole, into the motor housing from inside the lower housing. Therefore, the controller can also be cooled using the cooling air that cools the electric motor. In addition, by designing the air passage with a simple route that minimizes detours, the cooling air flow can maintain its momentum from the ventilation hole to the exhaustion hole.

According to other features of the present disclosure, a magazine that houses a plurality of driving members is arranged extending in the front-rear direction and in the up-down direction. The controller is rectangular and is housed in the lower housing such that a wide surface of the controller extends in its longitudinal direction in alignment with the magazine. The outside air from the ventilation hole flows between an inner surface of the lower housing and the wide surface of the controller along the longitudinal direction of the controller. Therefore, the controller can be compactly arranged around the magazine. In addition, the controller can be efficiently cooled by directing the cooling air toward the wide surface of the controller.

According to other features of the present disclosure, the upper portion of the magazine connects to the mechanism housing. The lower portion of the magazine connects to the lower housing. Therefore, the magazine connects to the mechanism housing at the upper portion and connects to the lower housing at the lower portion, thereby positioning the magazine in the vertical direction. As a result of this configuration, the magazine can be held with improved stability.

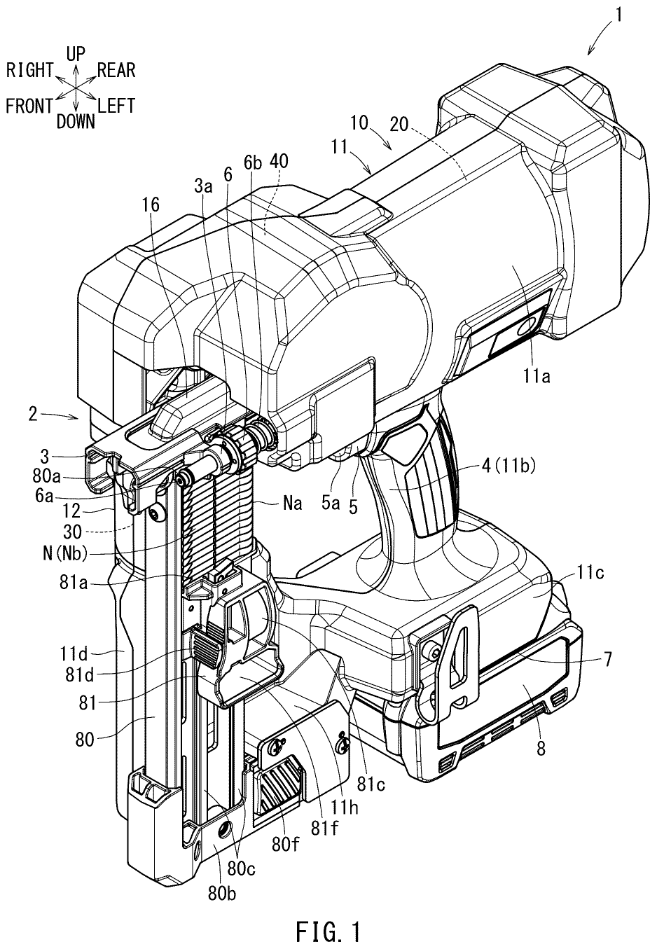

Next, a first embodiment of the present disclosure will be described with reference to FIGS. 1 to 20. As an example of a driving tool, a gas spring type driving tool 1, which uses a pressure of the gas filled in an accumulation chamber as the driving force for driving a driving member, is illustrated. The driving tool 1 shown in the embodiment is a fencing stapler that drives staples (driving members N) into wooden posts, etc. The driving tool 1 can be used to attach a fence including metal wires to the post together with staples. In the following description, the driving direction of the driving member N is defined as a forward direction, and a direction opposite to the driving direction is defined as a rearward direction. A user of the driving tool 1 generally stands behind the driving tool 1 to hold the handle 4. An upper, lower, leftward, and rightward directions are defined based on the user's position.

### Overall Structure of the Driving Tool 1

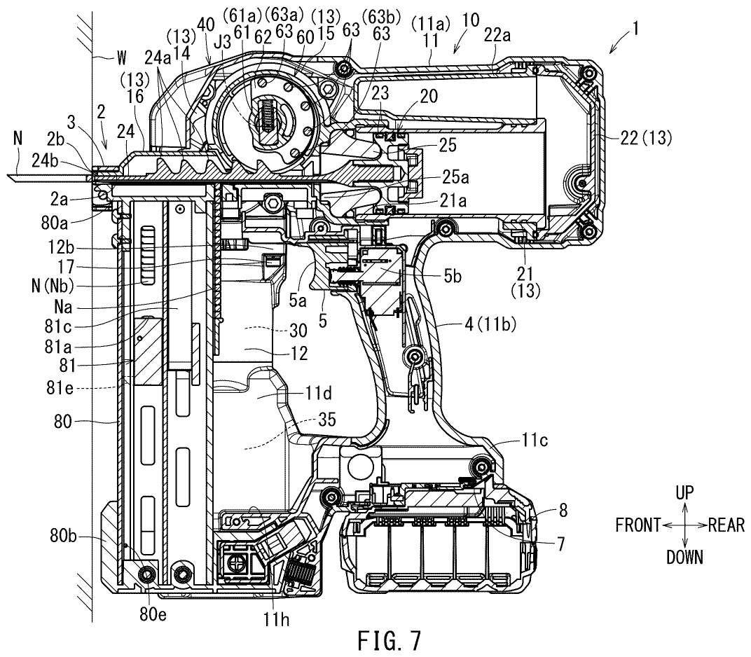

As shown in FIG. 1, the driving tool 1 has a tool main body 10 and a handle 4. The handle 4 extends downward from the tool main body 10. The tool main body 10 is provided with a driving mechanism 20, an electric motor 30, and a power transmission mechanism 40. The driving mechanism 20 moves a driver 24 (see FIG. 7) forward in a driving direction. The power transmission mechanism 40 transmits an output of the electric motor 30 to the driver 24. A lifter 60 (see FIG. 7) is arranged at the lowermost downstream end of the power transmission mechanism 40. The lifter 60 moves the driver 24 rearward in a direction opposite to the driving direction by receiving the output of the electric motor 30.

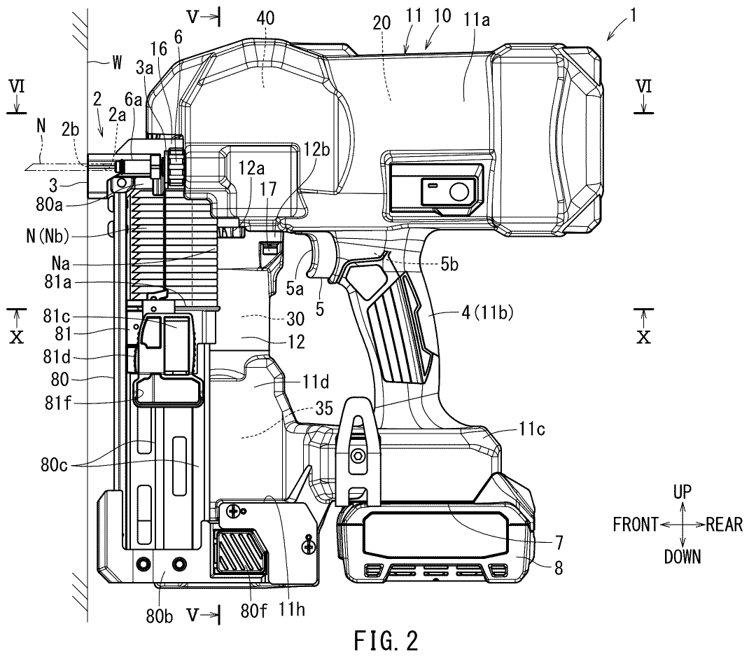

As shown in FIG. 2, a trigger 5 is positioned at the front upper portion of the handle 4. The trigger 5 has an operating surface 5a located at its front portion. A trigger switch 5b is situated inside the handle 4 behind the trigger 5. A user can hook a finger on the operating surface 5a while gripping the handle 4. The user can push toward the handle 4 (rearward) with the finger hooked on the operating surface 5a. This action pushes the trigger switch via the trigger 5, switching the trigger switch 5b from an off state to an on state. When in the on state, the trigger switch 5b transmits an on signal to the controller 35. The operation of the trigger 5 only becomes effective when the driving nose 2 is pressed against the workpiece W, causing the driving nose 2 to move rearward.

As shown in FIG. 2, a main body housing 11 covers the driving mechanism 20 and the power transmission mechanism 40. The main body housing 11 is made of, for example, synthetic resin. The main body housing 11 includes an upper housing 11a, a handle housing 11b, and a lower housing 11d. The upper housing 11a covers the driving mechanism 20 and at least a part of the power transmission mechanism 40. The handle housing 11b is tubular and extends downward from the upper housing 11a. The handle housing 11b forms an outer circumferential surface of the handle 4. An expanded portion 11c is connected to a lower portion of the handle housing 11b. The expanded portion 11c has a rectangular box shape with a width in both the front-rear direction and left-right directions greater than that of the handle housing 11b.

As shown in FIG. 2, a battery attachment portion 7 is arranged on the lower surface of the expanded portion 11c. The battery 8 can be detachably attached to the battery attachment portion 7. The battery 8 is attached to the battery attachment portion 7 by sliding the battery 8 from the rear to the front. On the other hand, the battery 8 is detached from the battery attachment portion 7 by sliding the battery 8 from the front to the rear. The battery 8 is located below the battery attachment portion 7 when attached to the battery attachment portion 7. The battery 8 supplies power to the electric motor 30 and other electric components. The battery 8 removed from the battery attachment portion 7 can be recharged by a dedicated charger for repeated use. The battery 8 can be used as a power source for other driving tools.

As shown in FIG. 2, the lower housing 11d is connected to a front portion of the expanded portion 11c of the handle housing 11b. The lower housing 11d is connected to a lower portion of the motor housing 12 that houses the electric motor 30. The lower housing 11d mainly houses a controller 35 that controls driving of the electric motor 30. An overall shape of the main body housing 11, which is connected to the upper housing 11a, the handle housing 11b, and the lower housing 11d, is C-shaped when viewed in the left-right direction. The motor housing 12 is located within the C-shaped opening of the main body housing 11 when viewed in the left-right direction.

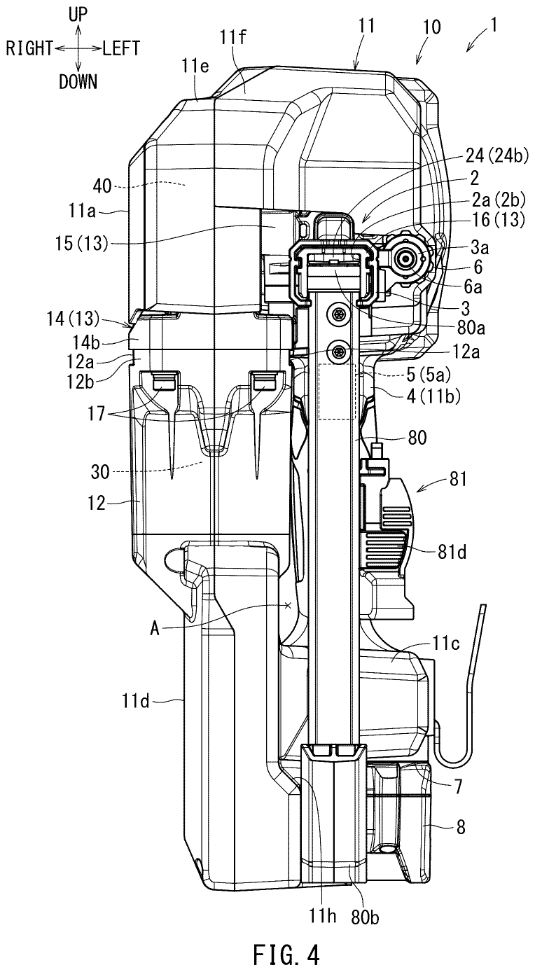

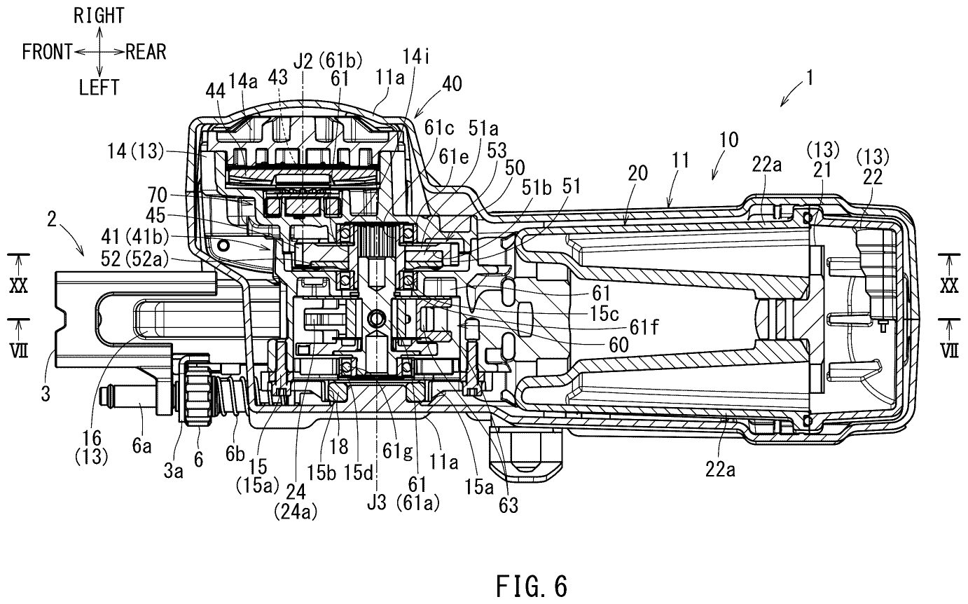

As shown in FIG. 4, the handle 4 and the trigger 5 are located at substantially the same position as the magazine 80 in the left-right direction. The lateral centers of the handle 4, the trigger 5, and the magazine 80 are approximately aligned, and for example, they are substantially aligned with the lateral center of the cylinder 21 (see FIG. 6). The handle 4 and the magazine 80 extend in the up-down direction and substantially parallel to each other. The motor housing 12 is located rightward of the trigger 5 and the magazine 80, and spaced apart from the trigger 5 and the magazine 80 in the left-right direction. The upper portion of the motor housing 12 slightly overlaps the handle 4 in the left-right direction, but the lower portion of the motor housing 12 is spaced apart from an outer surface of the handle 4 in the left-right direction. There is a space A between the motor housing 12 and the handle 4 in the left-right direction when viewed from the front.

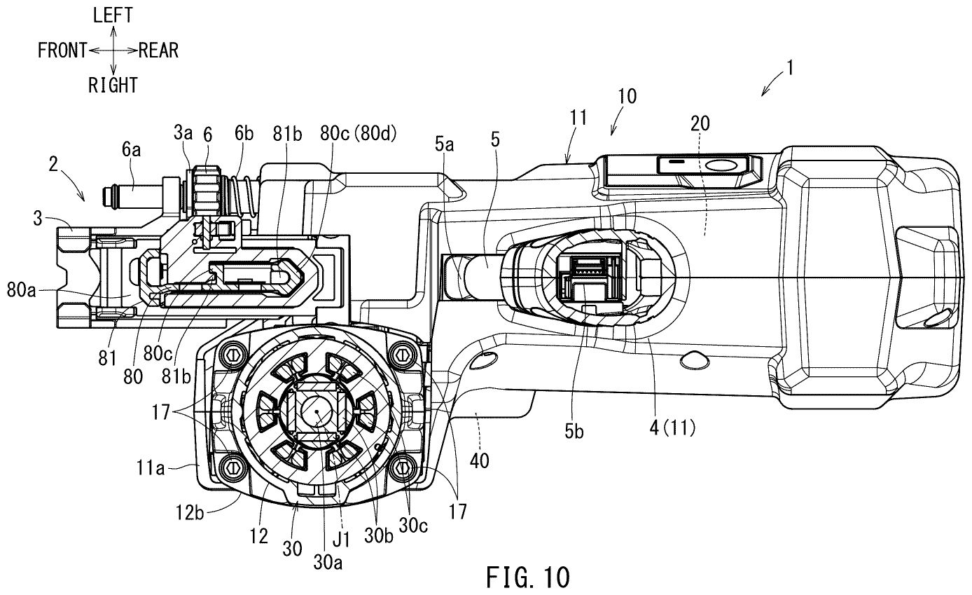

As shown in FIG. 2, the motor housing 12 is arranged adjacent to the magazine 80 in the left-right direction and overlaps with the magazine 80 in the front-rear direction. A rear end of the motor housing 12 is located forward of the operating surface 5a of the trigger 5 in the front-rear direction. As shown in FIG. 10, the motor housing 12 is located to the right of a region between the magazine 80 and the trigger 5 in the front-rear direction.

As shown in FIG. 2, a driving nose 2 is arranged at the front end of the tool main body 10. The driving nose 2 has a driver guide 16 that extends in the front-rear direction. A driving passage 2a that extends in the front-rear direction is arranged within the driver guide 16. An ejection port 2b opens toward the front at the front end of the driving passage 2a.

As shown in FIG. 2, the driving nose 2 has a contact arm 3 that contacts the workpiece W. The contact arm 3 is slidable in the front-rear direction relative to the driver guide 16. The contact arm 3 connects to the adjuster 6 via an adjuster connecting portion 3a. The adjuster 6 is arranged on the left side of the driving nose 2. The adjuster 6 is rotatable around an axis of the rotation shaft 6a that extends in the front-rear direction. By rotating the adjuster 6, the position of the contact arm 3 relative to the driver guide 16 can be adjusted in the front-rear direction.

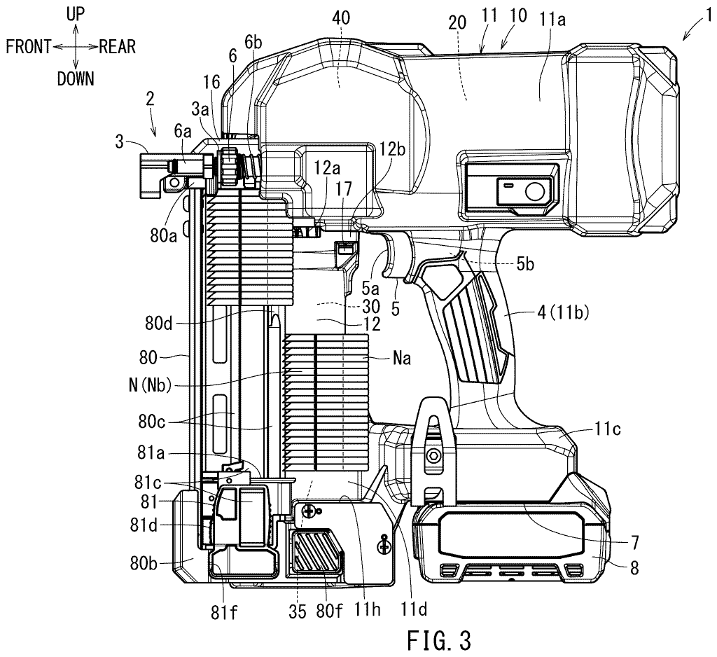

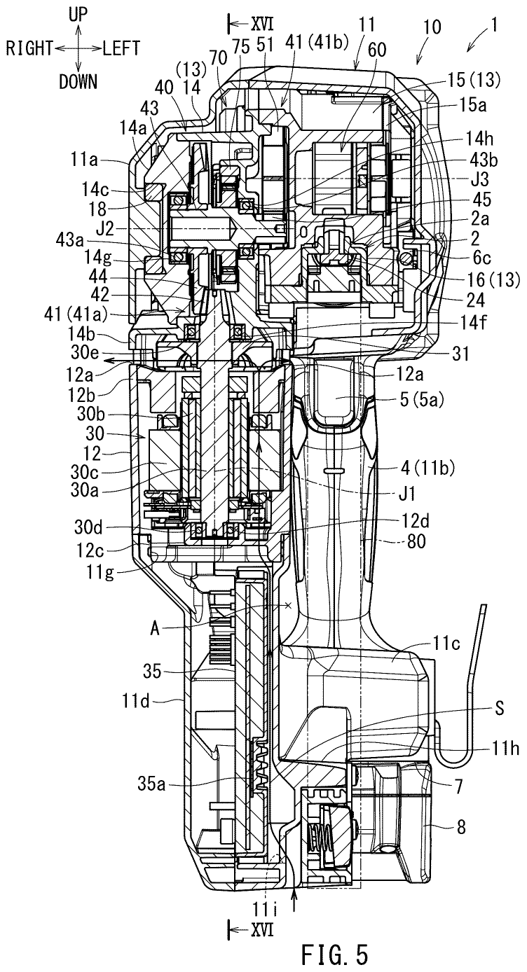

As shown in FIG. 3, the adjuster 6 is biased forward relative to the driver guide 16 by a compression spring 6b. The contact arm 4 that connects to the adjuster 6 is also biased forward relative to the driver guide 16 by the compression spring 6b. A switch 6c is arranged behind the adjuster 6 (refer to FIG. 5). As shown in FIG. 2, the contact arm 3 and the adjuster 6 move rearward when the contact arm 3 is pressed against the workpiece W. The switch 6c is actuated from an off state to an on state by being pressed, either directly or indirectly via a spring or the like against the adjuster 6. When switch 6c is in the on state, it transmits an on signal to the controller 35. When the on signal from switch 6c is transmitted to controller 35, a pulling operation of the trigger 5 becomes effective. When contact arm 3 is not pressed against workpiece W, the switch 6c is in the off state and does not transmit the on signal. Therefore, the pulling operation of the trigger 5 is not effective.

### Driving Mechanism 20

As shown in FIG. 7, the driving mechanism 20 has a cylinder 21, a piston 23, and a driver 24. The cylinder 21 is housed in the main body housing 11 and extends in the front-rear direction. The piston 23 can reciprocate move within the cylinder 21 in the front-rear direction. The driver 24 connects to the front surface of the piston 23 and extends in the front-rear direction. A rear end of the cylinder 21 connects to an accumulation chamber 22 at the rear of the piston 23. The accumulation chamber 22 is filled with a compressed gas such as air. The gas pressure in the accumulation chamber 22 acts as a thrust force on the rear surface of the piston 23, pushing it forward.

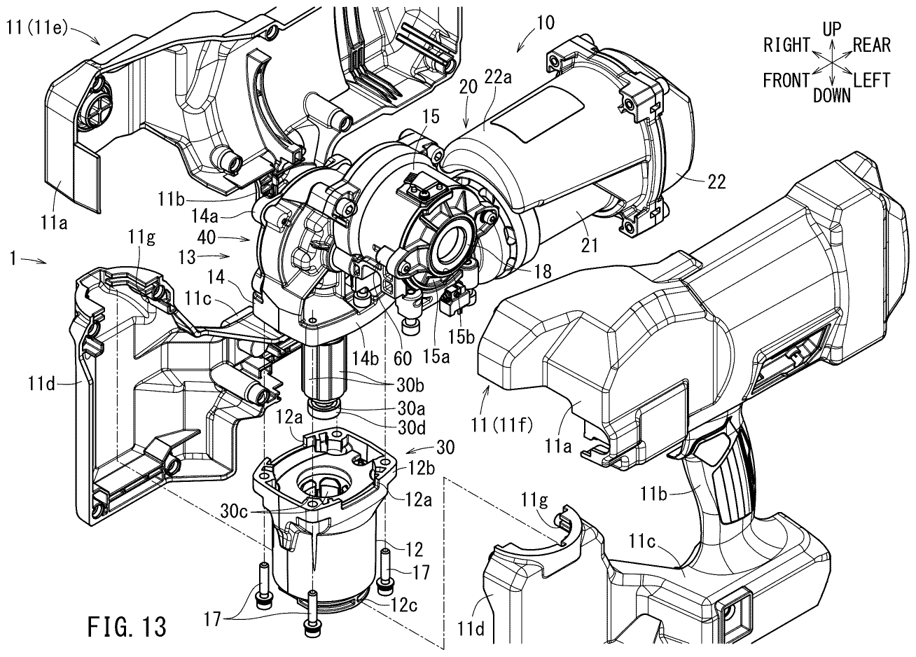

As shown in FIG. 7, the accumulation chamber 22 connects to an air chamber 22a above the cylinder 21. The air chamber 22a extends forward from the rear end of the cylinder 21. The air chamber 22a extends to an adjoining area of the rear end of the lifter 60. The air chamber 22a extends forward to a position approximately the same as the front end of the piston 23 when it is at the bottom dead center. The air chamber 22a is located behind the lifter 60. The height of the upper end of the air chamber 22a is approximately the same as the upper end of the lifter 60. As shown in FIG. 13, a lower surface of the air chamber 22a is formed in an arc shape to cover the outer circumferential surface of the cylinder 21 from above. The upper surface of the air chamber 22a is formed in an arc shape to follow the inner circumferential surface of the upper housing 11a.

As shown in FIG. 7, a tubular damper 25 is arranged at the front of the cylinder 21. The damper 25 is made of an elastic material such as rubber. The damper 25 absorbs the forward impact of the piston 23 when the piston 23 moves to the bottom dead center during the driving operation. The driver 24 is inserted through the center of the damper 25. A front end 25a of the damper 25 is located forward of the front end 21a of the cylinder 21. Furthermore, the front end 25a of the damper 25 is located rearward of the rear end of the lifter housing 15 and at approximately the same position as the rear end of the lifter 60 in the front-rear direction. The front end 25a of the cushion 25 and the front end 21a of the cylinder 21 are located rearward of the operating surface 5a of the trigger 5. The front end of the piston 23 at the bottom dead center is also located rearward of the operating surface 5a of the trigger 5.

As shown in FIG. 7, a plurality of rack teeth 24a projecting upward are arranged on the upper surface of the driver 24. In this embodiment, five rack teeth 24a are arranged in the front-rear direction, which is the longitudinal direction of the driver 24. The rack teeth 24a are triangular in shape when viewed from the left or right side. The front surface of the rack teeth 24a extends in a direction substantially perpendicular to the driving direction. The rear surface of the rack teeth 24a extends in a direction inclined forward toward the upper side. The rack teeth 24a are one example of engaged portions that engage the engaging pins (engaging portions) 63 of the lifter 60. When the lifter 60 rotates, the bottom surface of each rack teeth 24a engages a corresponding engaging pin 63. As a result, the driver 24 and the piston 23 move rearward (are retracted) against the gas pressure in the accumulation chamber 22.

Referring to FIG. 2, a driving member N housed in the magazine 80 is sequentially supplied to the driving passage 2a by a pusher 81. The driving member N is supplied to the driving passage 2a in a posture in which the head Na is located at the rear end and the legs Nb extend forward from the left and right ends of the head Na. Referring to FIG. 7, the driver 24 moves forward owing to the gas pressure in the accumulation chamber 22 during the driving operation. The tip end 24b located at the front end of the driver 24 moves forward and strikes (drives) the head Na of a single driving member N supplied to the driving passage 2a. As a result, the driving member N ejects from the ejection port 2b and is driven into the workpiece W.

### Mechanism Unit 13

As shown in FIG. 5, the tool main body 10 includes a gear housing 14 and a lifter housing 15 as a mechanism housing for housing the power transmission mechanism 40. The gear housing 14 houses a speed reduction mechanism 41 for reducing the output of the electric motor 30 in the power transmission mechanism 40. The lifter housing 15 houses the lifter 60 of the power transmission mechanism 40. The gear housing 14 is covered by the main body housing 11 except for a fastened portion 14b located at the bottom. An entirety of the lifter housing 15 is covered by the main body housing 11.

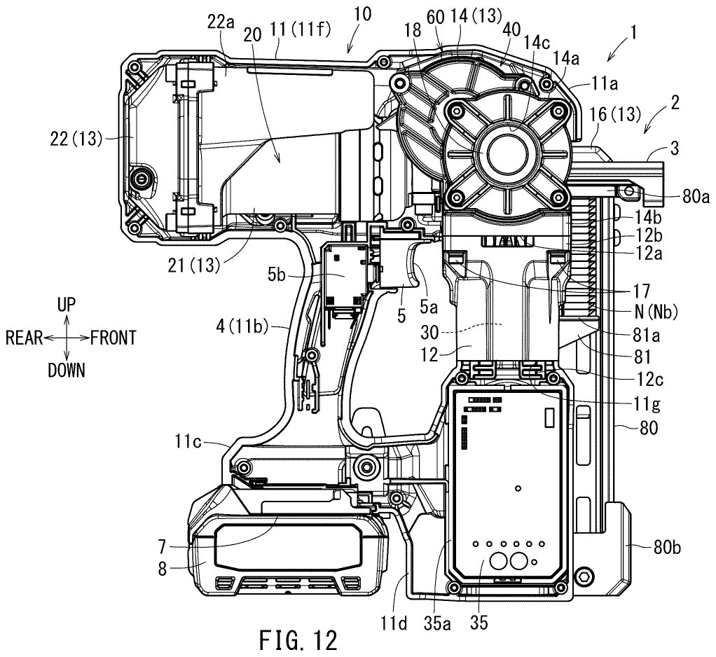

Referring to FIG. 13, the gear housing 14, the lifter housing 15, the cylinder 21, and the accumulation chamber 22 are integrally connected by screw fastening. Although omitted in FIG. 13 for clarity, the driver guide 16 and the cylinder 21 are also screw-fastened to the lifter housing 15 (refer to FIG. 12). In the present disclosure, a structure including the gear housing 14, the lifter housing 15, the driver guide 16, the cylinder 21, and the accumulation chamber 22 is referred to as the mechanism unit 13. Each structure forming the mechanism unit 13 is made of a material, such as aluminum or iron, having higher rigidity than the main body housing 11. Vibrations generated within the mechanism unit 13, such as those generated by sliding of the piston 23 and the movement of the driver 24, are transmitted throughout the mechanism unit 13 in the same vibration mode (refer to FIG. 7). The mechanism unit 13 is mostly covered by the upper housing 11a.

As shown in FIG. 12, a cap 14a is screw-fastened to the right side of the gear housing 14. The cap 14a covers the gear housing 14 in an airtight manner. A tubular ring holding portion 14c is recessed on the outer surface of the cap 14a (refer to FIG. 5). A rubber ring 18 is placed on the ring holding portion 14c as an elastic member. The rubber ring 18 is elastically held between the ring holding portion 14c on the outer surface of the cap 14a and the inner surface of the upper housing 11a (see FIG. 5). Accordingly, the rubber ring 18 reduces vibration transmission from the gear housing 14 to the main body housing 11.

As shown in FIG. 13, a cap 15a is screw-fastened to the left side of the lifter housing 15. The cap 15a covers the lifter housing 15 in an airtight manner. A tubular ring holding portion 15b is recessed on the outer surface of the cap 15a. A rubber ring 18 is placed on the ring holding portion 15b as an elastic member. The rubber ring 18 is elastically held between the ring holding portion 15b on the outer surface of the cap 15a and the inner surface of the upper housing 11a (see FIG. 6). Accordingly, the rubber ring 18 reduces vibration transmission from the lifter housing 15 to the main body housing 11.

### Electric Motor 30, Motor Housing 12, and Surrounding Structure

As shown in FIG. 5, a motor shaft 30a is arranged in the center of the electric motor 30. The motor shaft 30a extends in the up-down direction along the motor axis J1. The motor shaft 30a is rotatably supported by the bearing 30d at its lower end and by the bearing 30e at its upper end. The bearing 30d is inserted into the recess 12d formed in the lower portion of the motor housing 12. The bearing 30e is press-fitted into the recess 14f formed in the lower portion of the gear housing 14. A rotor 30b is integrally attached to the outer circumference of the motor shaft 30a. Therefore, the motor shaft 30a and the rotor 30b are supported by the gear housing 14 (refer to FIG. 13). Accordingly, vibrations of the mechanism unit 13 are transmitted to the motor shaft 30a and the rotor 30b.

As shown in FIGS. 4 and 12, the motor housing 12 is formed in a tubular shape and extends in the up-down direction. The motor housing 12 is made of a material that is more rigid than the main body housing 11, for example, a synthetic resin. A flange-shaped and rectangular tubular-shaped fastening portion 12b is formed at the upper portion of the housing 12, projecting radially outward from the tubular portion. As shown in FIG. 5, the stator 30c is fixed to the inner circumferential surface of the motor housing 12. The stator 30c is located radially outward from the rotor 30b.

As shown in FIGS. 4 and 12, a flange-shaped and rectangular tubular-shaped fastened portion 14b is formed at the lower portion of the gear housing 14. The fastened portion 14b has an outer peripheral shape that is substantially the same as that of the fastening portion 12b of the motor housing 12. The fastened portion 14b is exposed outside from the upper housing 11a. The fastening portion 12b of the motor housing 12 and the fastened portion 14b of the gear housing 14 are screw-fastened by bolts 17. The bolts 17 are fastened from the lower fastening portion 12b toward the upper fastened portion 14b. By screw-fastening of the motor housing 12 and the gear housing 14, vibrations with the same vibration mode as those of the mechanism unit 13 are transmitted to the motor housing 12 and the stator 30c.

As shown in FIG. 13, the outer periphery of the lower portion of the motor housing 12 has a connected portion 12c, which is provided with a groove extending in the circumferential direction. A connecting portion 11g, provided with a rib extending in the circumferential direction, is formed on the inner periphery of the upper portion of the lower housing 11d. The connecting portion 11g is engageable with the connected portion 12c. The main body housing 11 has a split structure divided in the left-right direction into a right housing 11e and a left housing 11f. The connected portion 12c of the motor housing 12 is sandwiched (clamped) between the divided left and right lower housings 11d. Because of this configuration, the connecting portion 11g engages the connected portion 12c, thereby positioning the motor housing 12 and the lower housing 11d relative to each other in the up-down direction.

As shown in FIG. 5, a fan 31 is attached to the upper portion of the motor shaft 30a. The fan 31 is located immediately below the bearing 30e and above the rotor 30b. The fan 31 rotates integrally with the motor shaft 30a to generate cooling air flowing upward from the lower portion to the upper portion of the motor housing 12. As shown in FIG. 4, exhaust holes 12a penetrating through both the inside and outside of the motor housing 12 are formed on the left and right sides of the fastening portion 12b of the motor housing 12. The exhaust holes 12a are located at substantially the same position as the fan 31 in the up-down direction. The upper end of the exhaust holes 12a is formed by the lower surface of the fastened portion 14b of the gear housing 14.

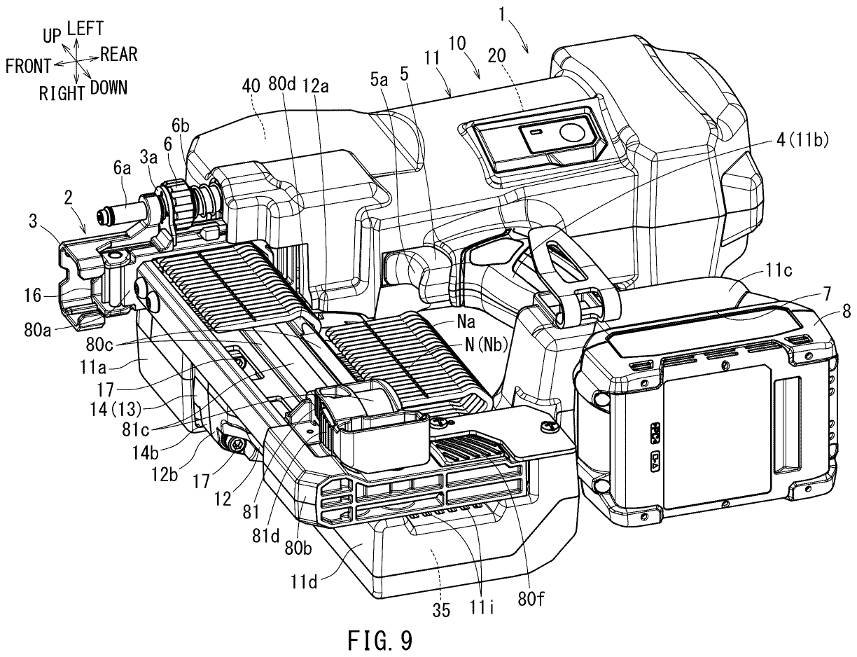

As shown in FIG. 12, a controller 35 is housed in the lower housing 11d. The controller 35 mainly controls the drive operation of the electric motor 30. The controller 35 is provided with a control board housed in a shallow rectangular box-shaped case 35a. The case 35a is made of, for example, aluminum having good heat conductivity. The controller 35 is housed in the lower housing 11d such that its longitudinal direction is directed in the up-down direction and the bottom surface (wide surface) of the case 35a is located to the left. The longest side of the controller 35 extends in the up-down direction and the shortest side extends in the left-right direction. As shown in FIG. 9, a ventilation hole 11i is located on the left side of the lower portion of the lower housing 11d, penetrating the lower housing 11d from the inside to the outside. The ventilation hole 11i is located so as to face the right side of the magazine 80 with a space in the left-right direction.

As shown in FIG. 5, an air passage S through which cooling air flows from the ventilation hole 11i to the exhaustion hole 12a is provided in the lower housing 11d and the motor housing 12. The air passage S extends upwardly between the left inner surface of the lower housing 11d and the bottom outer surface (wide surface) of the case 35a of the controller 35, starting from the air inlet 11i where outside air flows in. The air passage S extends further upward toward the motor housing 12 at the connecting portion between the lower housing 11d and the motor housing 12. When it reaches the fan 31, the cooling wind is discharged to the outside through the exhaustion hole 12a on the radial outer side of the fan 31. By the cooling wind flowing through the air passage S, the controller 35 and the motor 30 can be cooled.

### Speed Reduction Mechanism 41

As shown in FIG. 5, a speed reduction mechanism 41 is arranged above the electric motor 30. In this embodiment, the speed reduction mechanism 41 reduces the output of the electric motor 30 in two stages, an upstream speed reduction section 41a and a downstream speed reduction section 41b. A driving bevel gear 42 is arranged at the upper end of the motor shaft 30a. The driving bevel gear 42 is arranged immediately above the bearing 30e. This reduces the wobble of the driving bevel gear 42 relative to the bearing 30e when the driving bevel gear 42 rotates around the motor axis J1. Because of this configuration, engagement precision of the driving bevel gear 42 can be maintained. A driven bevel gear 44 engaging the driving bevel gear 42 is located to the right and above the driving bevel gear 42. The upstream speed reduction section 41a includes the driving bevel gear 42 and the driven bevel gear 44.

As shown in FIG. 5, the driven bevel gear 44 is integrally connected to an intermediate shaft 43. The intermediate shaft 43 extends in the left-right direction along an intermediate axis J2 that is perpendicular to the motor axis J1. The intermediate shaft 43 is rotatably supported around its axis via the bearings 43a and 43b. The bearing 43a is connected to the right end of the intermediate shaft 43. The bearing 43a is inserted into a recess 14g provided on the left side of the cap 14a. The driven bevel gear 44 is disposed immediately to the left of the bearing 43a. This reduces the wobble of the driven bevel gear 44 relative to the bearing 43a when the driven bevel gear 44 rotates around the axis of the intermediate shaft J2. Because of this configuration, engagement precision of the driven bevel gear 44 can be maintained. The bearing 43b connects to the left side of the intermediate shaft 43. The bearing 43b is press-fitted into a recess 14h provided on the inner side (right side) of the left side of the gear housing 14.

As shown in FIG. 5, a stopper 70 is positioned along the intermediate shaft 43, approximately in the middle of its length in the left-right (axial) direction. The stopper 70 regulates the rotation of the intermediate shaft 43 as it is configured to allow rotation in the forward rotation direction and to restrict rotation in the reverse rotation direction. The stopper 70 is located on the left side of the driven bevel gear 44 and immediately to the right of the bearing 43b. The stopper 70 overlaps the driving bevel gear 42 in the left-right direction by a length equal to at least half of the overall left-right width of the stopper 70 on the upper side of the driving bevel gear 42 and along (an extension line of) the motor axis J1. A driving spur gear (downstream driving gear) 45 is disposed at the left end of the intermediate shaft 43. The driving spur gear 45 is disposed to the left of the bearing 43b. The stopper 70 and the driving bevel gear 42 are situated between the driven bevel gear 44 and the driving spur gear 45 in the left-right direction. The intermediate shaft 43, the driven bevel gear 44, and the driving spur gear 45 all rotate integrally around the intermediate axis J2.

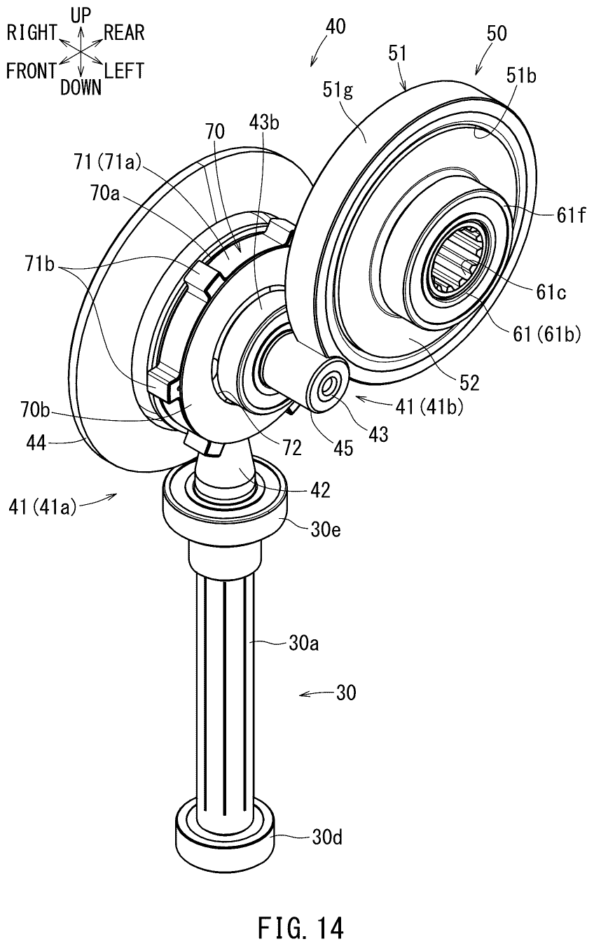

As shown in FIGS. 5 and 14, a washer 70a is disposed immediately to the right of the stopper 70. A washer 70b is disposed immediately to the left of the stopper 70. In other words, the stopper 70 is positioned between the left washer 70a and the right washer 70b.

As shown in FIG. 5, a driven spur gear 51 is disposed rearwardly and upwardly of the driving spur gear 45. The engagement between the driving spur gear 45 and the driven spur gear 51 forms a downstream speed reduction section 41b. Since the driven spur gear 51 is a speed reduction gear at the downstream end of the speed reduction mechanism, it is the final driven gear in this disclosure. As shown in FIG. 6, the driven spur gear 51 is rotatable around a lifter axis J3. The lifter axis J3 extends in the left-right direction, parallel to the intermediate axis J2, and is situated on the rear upper side of the intermediate axis J2. The driven spur gear 51 connects to the driving ring 52 via a buffering member 53. The buffering mechanism 50 includes the driven spur gear 51, the driving ring 52, and the buffering member 53. The driving ring 52 is rotatable around the lifter axis J3 together with the lifter shaft 61. Because of this configuration, the output of the electric motor 30 is reduced in the upstream speed reduction section 41a, and its direction of rotation is changed. Furthermore, the output of the electric motor 30 is further reduced in the downstream speed reduction section 41b and transmitted to the lifter shaft 61.

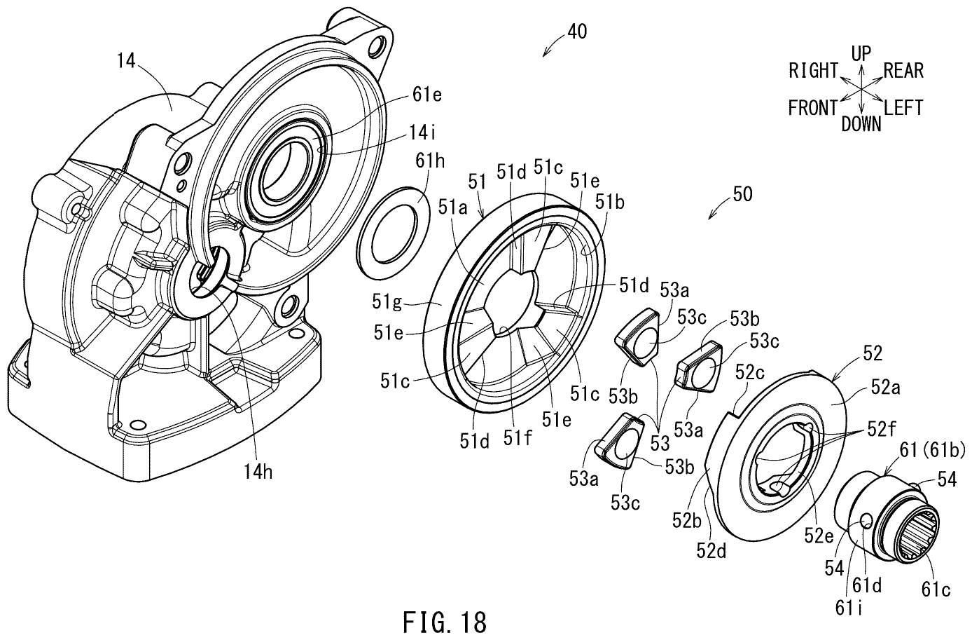

As shown in FIG. 6, the lifter shaft 61 is rotatably supported around the lifter axis J3 by three bearings 61e, 61f, and 61g. The bearing 61e connects to the right end of the lifter shaft 61. The bearing 61e is inserted into a recess 14i provided on the outside (left side) of the left-side surface of the gear housing 14. The driven spur gear 51 is located immediately to the left of the bearing 61e. A washer 61h (refer to FIG. 18) is positioned between the bearing 61e and the driven spur gear 51. The bearing 61f connects to the lifter shaft 61 approximately in the middle of the lifter shaft 61 in the left-right direction. The bearing 61f is located immediately to the left of the driven spur gear 51 and the driving ring 52. The bearing 61f is press-fitted into a recess 15c provided on the outside (right side) of the right-side surface of the lifter housing 15. The bearing 61g connects to the left end of the lifter shaft 61. The bearing 61g is inserted into a recess (not shown) on the right-side surface of the cap 15a. The lifter 60 is positioned axially (in the left-right direction) between the bearing 61f and the bearing 61g.

### Lifter

As shown in FIG. 7, the lifter 60 is located above the driver 24. A front end of the lifter 60 is located at approximately the same position as the rear end of the magazine 80 in the front-rear direction. The front end of the lifter housing 15 overlaps the magazine 80 in the front-rear direction. The rear end of the lifter 60 is located rearward of at least a part of the operating surface 5a of the trigger 5. The rear end of the lifter housing 15 is located rearward of the operating surface 5a of the trigger 5. The lifter 60 has a wheel 62 and a plurality of engaging pins (engaging portions) 63. The wheel 62 rotates in a counterclockwise direction in FIG. 7 when the lifter shaft 61 rotates around the lifter axis J3.

As shown in FIG. 7, a plurality of engaging pins 63 are arranged along an outer circumferential edge of the wheel 62. In this embodiment, five engaging pins 63 are arranged at substantially constant intervals in the circumferential direction of the wheel 62. The number of engaging pins 63 is the same as that of the rack teeth 24a provided on the driver 24. Each engaging pin 63 has a cylindrical shape, with its axis extending in the lateral direction. Each engaging pin 63 is held on the wheel 62 so as to be rotatable around its axis. The plural engaging pins 63 include a first engaging pin 63a and a last engaging pin 63b. The first engaging pin 63a is disposed at the leading end (frontmost position) in the rotational direction of the wheel 62 (counterclockwise direction in FIG. 7), while the last engaging pin 63b is disposed at the trailing end (rearmost position) in the same rotational direction.

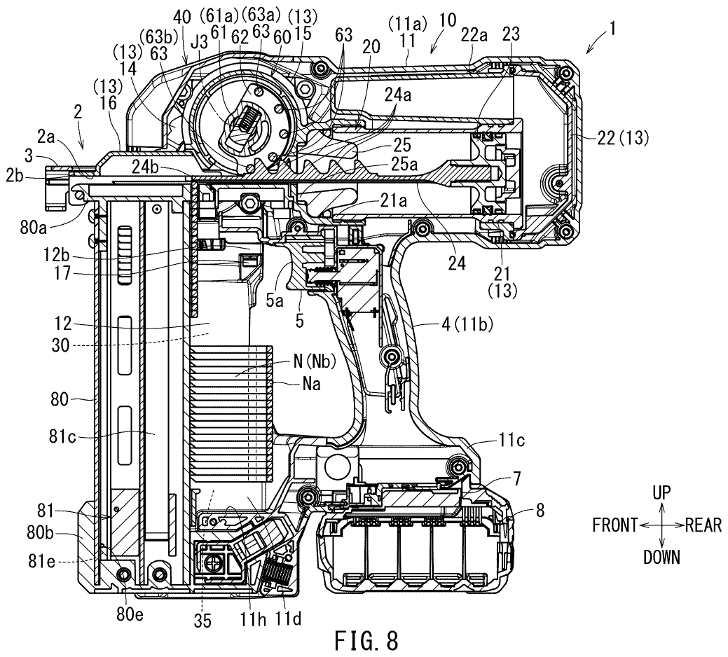

Referring to FIGS. 7 and 8, the first engaging pin 63a engages the bottom surface (front surface) of the rearmost rack tooth 24a among the plurality of rack teeth 24a during the normal operation. The last engaging pin 63b engages the bottom surface of the foremost rack tooth 24a among the plurality of rack teeth 24a during the normal operation. Each engaging pin 63 pushes the bottom surface of the corresponding rack tooth 24a in the rearward direction when the wheel 62 rotates in the counterclockwise direction in the figure. Because of this configuration, the driver 24 moves from the bottom dead center to the standby position and to the top dead center against the gas pressure in the accumulation chamber 22.

In the case of an abnormal operation where the driver 24 cannot be driven to the bottom dead center due to, for example, a nail jamming in the driving passage 2a, there may be a misalignment in which, for example, the first engaging pin 63a engages a second rack tooth 24a adjacent to the rearmost rack tooth. In such a case, after the nail jamming is cleared, the driver 24 moves to the bottom dead center during the next driving operation, thereby returning to the normal operation where the first engaging pin 63a engages the rearmost rack tooth 24a.

As shown in FIG. 7, the wheel 62 has a fan-shaped profile when viewed from the left or right side. A central angle of the fan-shaped wheel 62 is less than 180°. The outer diameter of the wheel 62 is such that the central angle of the fan shape is less than 180° and the circumferential distance from the first engaging pin 63a to the last engaging pin 63b is set to be equal to the distance from the rearmost rack tooth 24a to the foremost rack tooth 24a in the front-rear direction.

### Stopper 70

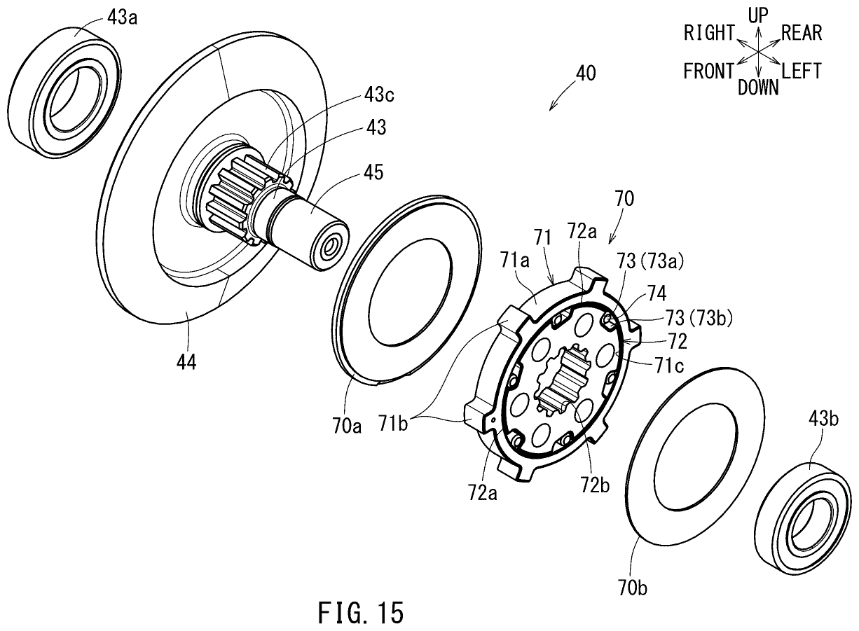

As shown in FIG. 15, the stopper 70 has a cylindrical outer ring 71 and a cylindrical inner ring 72. The inner ring 72 is housed on the inner circumferential side of the outer ring 71. The inner circumferential surface 71c of the outer ring 71 and the outer circumferential surface 72a of the inner ring 72 face each other with a slight radial clearance. The outer ring 71 and the inner ring 72 have approximately the same width in the axial (left-right) direction.

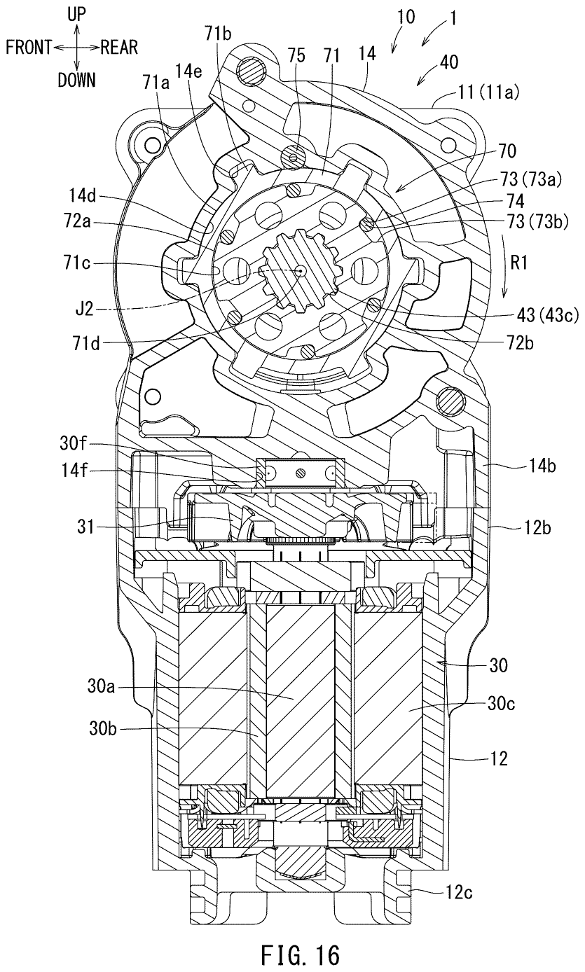

As shown in FIG. 15, a plurality of projections 71b projecting radially outward are formed on the outer circumferential surface 71a of the outer ring 71. The plurality of projections 71b are formed, for example, at intervals of approximately 60° in the circumferential direction of the outer circumferential surface 71a. As shown in FIG. 16, the inner side of the gear housing 14 has a circular inner circumferential surface 14d and a plurality of grooves 14e recessed radially outward from the inner circumferential surface 14d when viewed from the left or right side. The inner circumferential surface 14d of the gear housing 14 faces the outer circumferential surface 71a of the outer ring 71 with a slight space in the radial direction. The plurality of projections 71b of the outer ring 71 can be inserted into the plurality of grooves 14e of the gear housing 14. As a result, the outer ring 71 is prevented from rotating around the intermediate axis J2 and held in the gear housing 14.

As shown in FIG. 15, a spline groove 72b is formed at the radially central portion of the inner ring 72. A spline shaft 43c that engages the spline groove 72b is formed on the outer circumference of the intermediate shaft 43. By engaging the spline groove 72b with the spline shaft 43c, the inner ring 72 rotates integrally with the intermediate shaft 43 around its axis (J2).

As shown in FIG. 15, a plurality of wedge grooves 73 are formed on the outer circumferential surface 72a of the inner ring 72. In this embodiment, six wedge grooves 73 are formed at intervals of approximately 60° in the circumferential direction. A cylindrical wedge member 74 is inserted into each wedge groove 73. The length of the wedge member 74 in the axial direction (left-right direction) is approximately the same as the width of the outer ring 71 and/or inner ring 72 in the axial direction. The wedge member 74 each is held in place by the left and right washers 70a and 70b such that it cannot slip out of the wedge groove 73.

As shown in FIG. 16, the wedge grooves 73 are recessed radially inward from the outer circumferential surface 72a of the inner ring 72 and extend circumferentially longer than the groove depth. Each wedge groove 73 is formed in substantially the same shape. The groove depth of the wedge grooves 73 gradually becomes shallower in the forward rotation direction R1. The rear portion of the wedge groove 73 in the forward rotation direction R1 is a deep groove portion 73a in which the groove depth is greater than the diameter of the wedge member 74. The front portion of the wedge groove 73 in the forward rotation direction R1 is a shallow groove portion 73b in which the groove depth is smaller than the diameter of the wedge member 74.

As shown in FIG. 16, when the inner ring 72 rotates in the forward rotation direction R1, each wedge member 74 moves toward the deep groove portion 73a within the wedge groove 73. Therefore, a space is formed between each wedge member 74 and the inner circumferential surface 71c of the outer ring 71 and/or between each wedge member 74 and the bottom of the deep groove 73a. Because of this configuration, when the inner ring 72 rotates in the forward rotation direction R1, the lifter 60 rotates in the forward rotation direction R1. Accordingly, the intermediate shaft 43, the driven bevel gear 44, and the driving spur gear 45 rotate together with the inner ring 72 in the forward rotation direction R1 (refer to FIG. 5). When the inner ring 72 rotates in the forward rotation direction R1, the lifter 60 rotates in the counterclockwise direction in FIG. 7.

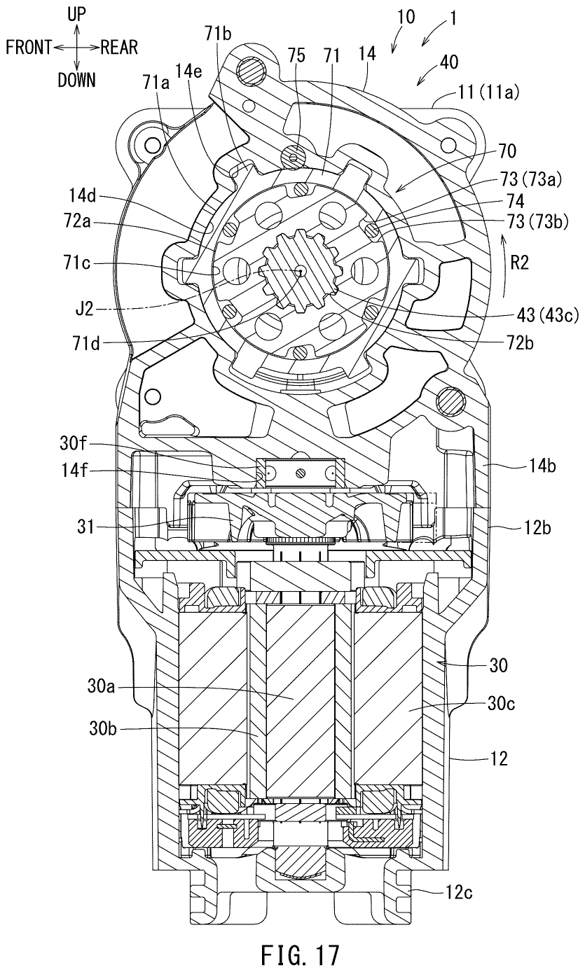

As shown in FIG. 17, when the inner ring 72 is urged to rotate in the reverse rotation direction R2, each wedge member 74 moves within the wedge groove 73 toward the shallow groove portion 73b. As a result, each wedge member 74 is clamped (wedged) between the inner circumferential surface 71c of the outer ring 71 and the shallow groove portion 73b of the wedge groove 73. For example, when there are three or more wedge members 74 clamped between the inner circumferential surface 71c of the outer ring 71 and the wedge grooves 73, rotation of the inner ring 72 is restricted in the reverse rotation direction R2. More specifically, rotation of the inner ring 72 in the reverse rotation direction R2 is restricted when the intermediate axis J2 is located inside a triangle formed by the clamped three wedge members 74 in left and right side views. When the inner ring 72 is urged to rotate in the reverse rotation direction R2, the lifter 60 is caused to rotate in the clockwise direction in FIG. 7.

As shown in FIG. 16, an elastic member 75, such as a cylindrical rubber member, is placed between the upper portion of the outer circumferential surface 71a of the outer ring 71 and the inner circumferential surface 14d of the gear housing 14. The function of the elastic member 75 is to bias the outer ring 71 downward. This downward bias utilizes the dimensional tolerance for assembly between the outer circumferential surface 71a of the outer ring 71 and the inner circumferential surface 14d of the gear housing 14 to slightly displace the outer ring 71 downward. As a result of this displacement, the center 71d of the inner circumferential surface 71c of the outer ring 71, which serves as the center of rotation of the outer ring 71, is located slightly below the intermediate axis J2, which is the center of rotation of the inner ring 72. This configuration causes the radial distance between the bottom of each wedge groove 73 and the inner circumferential surface 71c of the outer ring 71 to vary depending on the position of each wedge groove 73. Specifically, the distance is slightly shorter in the wedge grooves 73 located above the intermediate axis J2. The distance is slightly longer in the wedge grooves 73 located below the intermediate axis J2.

The inner ring 72 normally rotates in the forward rotation direction R1. Therefore, each of the wedge member 74 is located generally in the deep groove portion 73a. A lubricant such as grease is filled in places such as those where gears engage each other in the gear housing 14. For example, grease may inadvertently enter the wedge groove 73 and solidify. In such a case, the wedge member 74 located in the deep groove portion 73a may not be able to pass over the solidified grease, etc., and may be prevented from moving to the shallow groove portion 73b when the inner ring 72 rotates in the reverse rotation direction R2. Even in such a case, by biasing the outer ring 71 with the elastic member 75, the wedge groove 73, which has a short radial distance between the bottom of the groove and the inner circumferential surface 71c of the outer ring 71, always exists. Accordingly, even if the wedge member 74 is prevented from moving due to grease, etc., the wedge member 74 can be clamped (wedged) between the bottom of the wedge groove 73 and the inner circumferential surface 71c of the outer ring 71. Thus, the wedge members 74 can more reliably restrict the rotation of the inner ring 72 in the reverse rotation direction R2.

There is a time lag between the moment the inner ring 72 starts rotating in the reverse rotation direction R2 and the point at which the stopper 70 brings it to a stop. Therefore, the inner ring 72 continue to rotate in the reverse rotation direction R2 from the moment it starts until it comes to a stop. A rotation angle of the inner ring 72 before it comes to a stop is not constant, but varies within a certain range. As shown in FIG. 14, the stopper 70 is positioned on the upstream side of the downstream speed reduction section 41b. For example, if the reduction ratio of the downstream speed reduction section 41b is 1/10, the rotation angle of the lifter shaft 61 from the start of reverse rotation to its stop is 1/10 of the rotation angle of the intermediate shaft 43, which is integrated with the inner ring 72. The rotation angle of the lifter shaft 61 is proportional to the amount of movement of the driver 24 in the front-rear direction. Accordingly, placing the stopper 70 on the upstream side of the downstream speed reduction section 41b allows for reduction in the amount of the front-rear movement of the driver 24 during reverse operation of the lifter 60, and also helps minimize movement error.

As shown in FIG. 5, the stopper 70 is located on the downstream side of the upstream speed reduction section 41a. Considering only the reduction ratio, it is preferable to located the stopper 70 on the upstream side of the driving bevel gear 42. However, when the stopper 70 is located between the driving bevel gear 42 and the bearing 30e, the driving bevel gear 42 is separated from the bearing 30e. Therefore, it is difficult to effectively suppress the wobble of the driving bevel gear 42 supported by the bearing 30e. Thus, it is difficult to located the stopper 70 on the upstream side of the driving bevel gear 42. The driven bevel gear 44 is provided with a diameter equal to or greater than a specified value in order to achieve the required reduction ratio relative to the driving bevel gear 42. Therefore, it is easy to secure a space for positioning the stopper 70 in the vicinity of the driven bevel gear 44. Accordingly, in the present embodiment, the stopper 70 is positioned on the downstream side of the upstream speed reduction section 41a and on the upstream side of the downstream speed reduction section 41b.

### Buffering Mechanism 50

As shown in FIG. 18, a buffering mechanism 50 has a driven spur gear 51 as an upstream rotating member and a driving ring 52 as a downstream rotating member. A disc-shaped upstream disc portion 51a is disposed on the right side of the driven spur gear 51. The upstream disc portion 51a extends in a flat plate shape perpendicular to the left-right direction. An outer circumferential surface of the driven spur gear 51 extends in a cylindrical shape to the left from the upstream disc portion 51a. External teeth 51g that engage the driving spur gear 45 (refer to FIG. 14) are formed on the outer circumferential surface of the driven spur gear 51. A recess 51b opening toward the left side is formed on the inner circumferential surface of the outer circumferential surface of the driven spur gear 51. A circular hole 51f is formed at the radial center of the driven spur gear 51, penetrating the upstream disc portion 51a in the left-right direction. The lifter shaft 61 is inserted into the hole 51f.

As shown in FIG. 18, a plurality of upstream protrusions 51c project to the left from the upstream disc portion 51a and are formed within the recess 51b of the follower spur gear 51 (also referred to as the driven spur gear). In this exemplary embodiment, three upstream protrusions 51c are formed, arranged at intervals of approximately 120° in the circumferential direction. When viewed from the left or right side, the upstream protrusions 51c are fan-shaped. The left end face of the upstream protrusion 51c is a flat surface, parallel to the upstream disc portion 51a. The left end face of the upstream protrusion 51c is located to the right of the left end of the entire driven spur gear 51. More specifically, its position to the right corresponds to a length equal to the thickness of a downstream disc portion 52a. When the driven spur gear 51, the buffering member 53, and the driving ring 52 are assembled, at least a part of the downstream spur gear 52a is housed in the recess 51b of the follower spur gear 51. More preferably, the entirety of the downstream spur gear 52a is housed within the recess 51b.

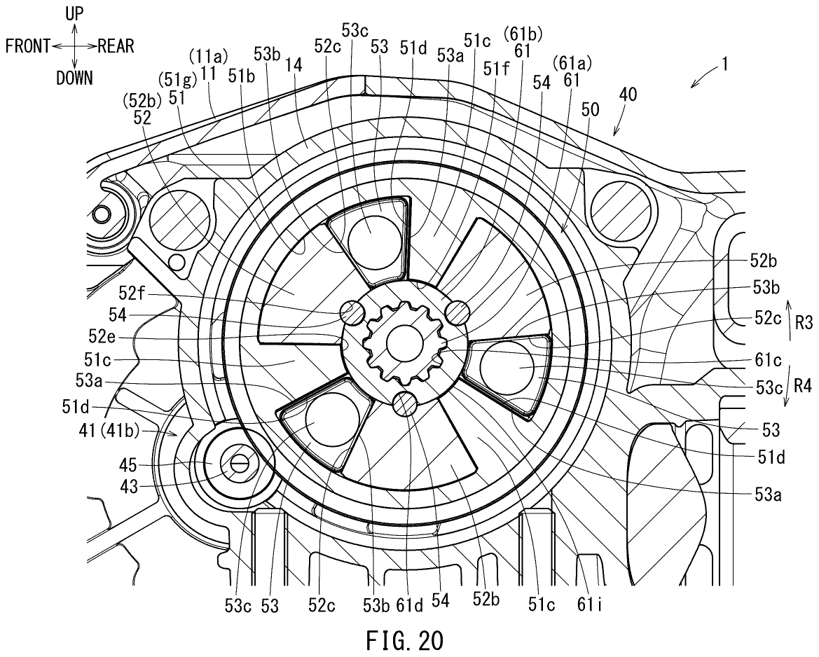

As shown in FIG. 18, the upstream protrusion 51c has an upstream side surface 51d in front of the forward rotation direction R3 (refer to FIG. 20) and an upstream inclined side surface 51e behind the forward rotation direction R3. The upstream side surface 51d and the upstream inclined side surface 51e extend in a flat surface in the radial direction between the outer circumferential surface of the follower spur gear 51 and the hole 51f. The upstream side surface 51d is perpendicular to the upstream disc portion 51a. The upstream inclined side surface 51e is inclined toward the rear of the forward rotation direction R3 as it approaches the upstream disc portion 51a from the left to the right. The upstream inclined side surface 51e is inclined at an inclination angle of, for example, 30° to 60° with respect to the upstream disc portion 51a.

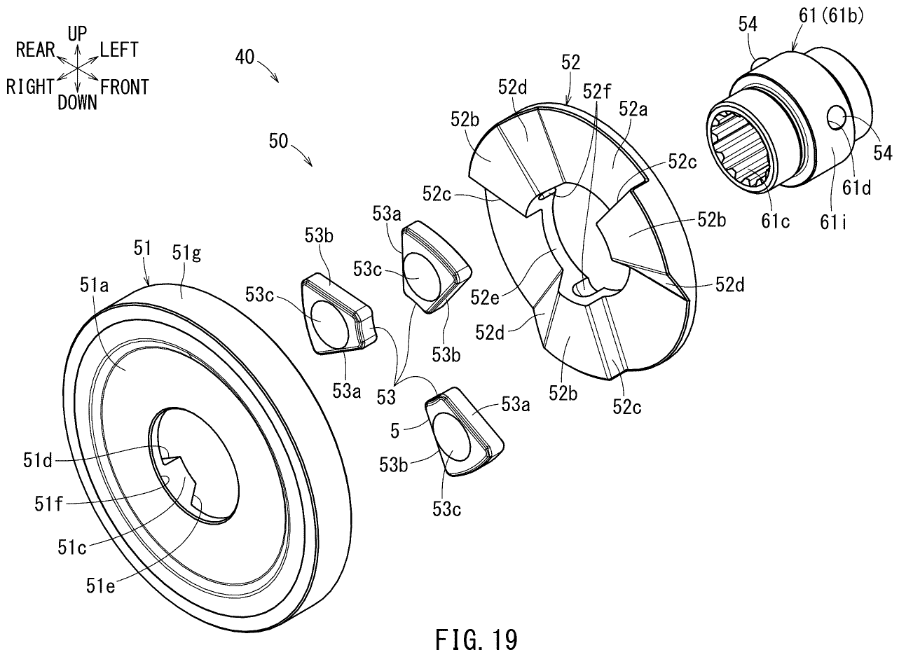

As shown in FIGS. 18 and 19, the left side of the driving ring 52 is a disc-shaped downstream disc portion 52a. The downstream disc portion 52a extends in a flat plate shape perpendicular to the left-right direction. A circular hole 52e is formed in the radial center of the driving ring 52, penetrating the downstream disc portion 52a in the left-right direction. The lifter shaft 61 is inserted into the hole 52e. The driving ring 52 has a plurality of downstream protrusions 52b projecting to the right from the downstream disc portion 52a. In this embodiment, three downstream protrusions 52b are formed at intervals of approximately 120° in the circumferential direction. The downstream protrusions 52b are fan-shaped when viewed from the left or right side. The right end surface of the downstream protrusions 52b is flat and parallel to the downstream disc portion 52a.

As shown in FIG. 19, each of the downstream protrusions 52b has a downstream inclined side surface 52d in front of the forward rotation direction R3 (refer to FIG. 20) and a downstream side surface 52c behind the forward rotation direction R3. Both the downstream side surface 52c and the downstream inclined side surface 52d extend as a flat surface in the radial direction. This extension runs from the central hole 52e of the driving ring 52 out to its outer circumferential edge. The downstream side surface 52c is perpendicular to the downstream disc portion 52a. The downstream inclined side surface 52d is inclined toward the rear of the forward rotation direction R3. This inclination approaches the downstream disc portion 52a as it moves from the right to the left. The downstream inclined side surface 52d is inclined toward the downstream disc portion 52a at an angle that is approximately the same as the inclination angle of the upstream inclined side surface 51e.

As shown in FIGS. 18 and 19, the driving ring 52 has a plurality of ball grooves 52f that communicate with the hole 52e. The plurality of ball grooves 52f are formed on each of the inner peripheral edge of the downstream protrusions 52b. Specifically, three ball grooves 52f are formed in total. The ball grooves 52f extend from the left side of the downstream disc portion 52a toward the right. Each ball groove 52f has a tubular surface on the opening side (left side) and a spherical surface on the bottom side (right side). The groove depth of each ball groove 52f is approximately constant in the left-right direction.

As shown in FIG. 18, three buffering members 53 are provided in the buffering mechanism 50. The buffering members 53 are made of, for example, a highly elastic rubber. The buffering members 53 are formed in a substantially same shape. The buffering members 53 are fan-shaped when viewed from the left or right side. An outer circumferential surface of the buffering members 53 faces the inner circumferential surface of the recess 51b of the follower spur gear 51 in the radial direction. The inner circumferential surface of the buffering members 53 faces the outer circumferential surface 61i of the lifter shaft 61 in the radial direction. The buffering members 53 have a substantially constant thickness in the left-right direction, except at the protrusions 53c described later.

As shown in FIG. 20, each of the buffering member 53 has a second side surface 53b in front of the forward rotation direction R3 and a first side surface 53a behind the forward rotation direction R3. The first side surface 53a and the second side surface 53b extend in a flat surface in the left-right direction. The first side surface 53a and the second side surface 53b are perpendicular to the upstream disc portion 51a and/or the downstream disc portion 52a. The first side surface 53a and the second side surface 53b are based on the positional relationship when the buffering member 53 is assembled between the follower spur gear 51 and the driving ring 52. Since the buffering member 53 has a symmetrical shape before assembly, it can be properly installed between the driven spur gear 51 and the driving ring 52 even if the illustrated first side surface 53a and the second side surface 53b are reversed.

As shown in FIGS. 18 and 19, a protrusion 53c is provided at the center of both left and right side surfaces of the buffering member 53. The protrusion 53c extends spherically outward from the buffering member 53 to both the left and right sides. The protrusion 53c is circular in shape when viewed from the left or right side. The right protrusion 53c elastically contacts the left side surface of the upstream disc portion 51a. The left protrusion 53c elastically contacts the right side of the downstream disc portion 52a. As shown in FIG. 6, the buffer member 53 is clamped between the upstream disc portion 51a and the downstream disc portion 52a in the left-right direction. The buffer member 53 is housed within the width of the follower spur gear 51 in the left-right direction.

As shown in FIG. 20, the buffering member 53 is housed between the upstream protrusion 51c and the downstream protrusion 52b in the circumferential direction. The first side surface 53a of the buffering member 53 elastically contacts the upstream side surface 51d of the driven spur gear 51 in the circumferential direction. The second side surface 53b of the buffering member 53 elastically contacts the downstream side surface 52c of the driving ring 52 in the circumferential direction. As shown in FIG. 18, the upstream inclined side surface 51e of the driven spur gear 51 and the downstream inclined side surface 52d of the driving ring 52 face each other when assembled.

By providing the upstream inclined side surface 51e of the driven spur gear 51 and the downstream inclined side surface 52d of the driving ring 52, it is possible to prevent the buffering member 53 from being housed in an incorrect position. For example, even if the buffering member 53 is urged to the space between the upstream inclined side surface 51e and the downstream inclined side surface 52d, the buffering member 53 cannot be housed there. This is because the upstream inclined side surface 51e and the downstream inclined side surface 52d are inclined with respect to each outer surface of the buffering member 53. Consequently, the buffering member 53 cannot be assembled correctly in that orientation. During the assembly process, the follower spur gear 51 is rotated in the forward rotation direction R3 relative to the driving ring 52. This brings the upstream inclined side surface 51e closer to the downstream inclined side surface 52d in the circumferential direction. As a result, the upstream side surface 51d presses the first side surface 53a of the buffering member 53 in the circumferential direction, moving the buffering member 53 to its normal position for correct assembly.

As shown in FIG. 6, the lifter shaft 61 is arranged as an integral shaft member by connecting the left shaft main body 61a and the right shaft sleeve 61b. A wheel 62 connects to the shaft main body 61a. The buffering mechanism 50 connects to the shaft sleeve 61b. A spline groove 61c, which engages a spline shaft of the shaft main body 61a, is formed at the radial center of the shaft sleeve 61b.

As shown in FIGS. 19 and 20, three ball holes 61d are formed on an outer circumferential surface 61i of the shaft sleeve 61b at intervals of approximately 120° in the circumferential direction. The ball holes 61d are recessed radially inward in a hemispherical shape. A metal balls 54 is inserted into each of the ball hole 61d. The hemispherical portions of the balls 54 projecting radially outward from the ball holes 61d are inserted into the ball grooves 52f of the driving ring 52. Because of this configuration, the driving ring 52 integrally connects to the shaft sleeve 61b via the balls 54. The driving ring 52 is integrally rotatable around the lifter axis J3 together with the lifter shaft 61.

As shown in FIG. 20, the driven spur gear 51 is rotated in the forward rotation direction R3 around the lifter axis J3 by receiving power transmitted from the driving spur gear 45. At this time, the upstream side surface 51d of the driven spur gear 51 elastically presses the first side surface 53a of the buffering member 53 in the forward rotation direction R3. Furthermore, the second side surface 53b of the buffering member 53 elastically presses the downstream side surface 52c of the driving ring 52 in the forward rotation direction R3. As a result, the driving ring 52 rotates in the forward rotation direction R3 around the lifter axis J3 together with the lifter shaft 61. Accordingly, the lifter 60 rotates counterclockwise in the forward rotation direction, as illustrated in FIG. 7.

As illustrated in FIG. 20, the driving ring 52 may be caused to rotate in the reverse rotation direction R4 together with the lifter shaft 61. In more detail, the lifter shaft 61 may rotate in the reverse direction when the impact from the driving operation of the driver 24 or its rearward movement is transmitted to the lifter 60 (see FIG. 7). In addition, for example, when the lifter 60 and the driver 24 are misaligned and the engaging pin 63 of the lifter 60 comes into contact with the rack tooth 24a of the driver 24 moving forward, the lifter shaft 61 may rotate in the reverse direction. At this time, the downstream side surface 52c of the driving ring 52 elastically pushes the second side surface 53b of the buffering member 53 in the reverse rotation direction R4. Furthermore, the first side surface 53a of the buffering member 53 elastically pushes the upstream side surface 51d of the driven spur gear 51 in the reverse rotation direction R4. Accordingly, the impact applied to the driving ring 52 is reduced by the buffering member 53, thereby suppressing the impact from being transmitted to the driven spur gear 51 and upstream components. Since the driven spur gear 51 is the final-stage speed reduction gear of the speed reduction mechanism 41, the buffering mechanism 50 can suppress the transmission of impact from the lifter 60 to all the reduction gears in the speed reduction mechanism 41.

### Magazine 80

As shown in FIG. 1, the magazine 80 formed in a substantially rectangular box shape is arranged below the driving nose 2. The magazine 80 extends straight downward from the driver guide 16. The magazine 80 connects to the driver guide 16 at the upper portion 80a. Also, the magazine 80 connects to the lower housing 11d at the lower portion 80b. The magazine 80 is mainly made of metal and has high rigidity. Due to this configuration, the mechanism unit 13 (see FIG. 7) and the lower housing 11d are connected in the up-down direction not only via the motor housing 12 but also via the magazine 80.

As shown in FIG. 2, a plurality of driving members N are loaded in the magazine 80 in parallel in the up-down direction. The driving members N are loaded in the magazine 80 in a posture in which the head Na is located at the rear end and a pair of legs Nb extend forward from the left and right ends of the head Na. The magazine 80 is provided with a pusher 81 for supplying the driving members N to the driving passage 2a located above. The pusher surface 81a of the upper end of the pusher 81 biases the plural driving members N upward. The pusher 81 has a spiral spring 81c as a biasing member that biases it upward.

As shown in FIG. 3, the magazine 80 is provided with a front rail 80c and a rear rail 80c that extend straight in the up-down direction. The upper portion of the rear rail 80c includes a bulging section 80d that projects in the lateral (left-right) direction. The head Na of the driving member N is held so as not to fall out, for example, rearwardly from the magazine 80 by being inserted into the bulging section 80d. As shown in FIG. 10, the pusher 81 has rail engagement portions 81b that engage with the rails 80c. The pusher 81 is slidable in the up-down direction along the rails 80c.

As shown in FIG. 1, a lock release lever 81d is arranged at the front portion of the pusher 81. The user can push the lock release lever 81d with a finger. A box-shaped recess 81f is formed at the lower portion of the pusher 81. The recess 81f opens toward the left and is surrounded by walls on the front, rear, top, bottom, and right sides. The user can press the lock release lever 81d with one finger while hooking another finger into the recess 81f. Accordingly, the lock release lever 81d can be pressed and the pusher 81 can be slid up-down direction with one hand.

As shown in FIGS. 1 and 8, a pair of claws 81e are provided integrally with the lock release lever 81d. The claws 81e project forward in an L shape. The claws 81e and the lock release lever 81d are biased forward by a biasing member (not shown). When the lock release lever 81d is pushed rearward, the claws 81e also move rearward. A claw engagement portion 80e is provided at the front end of the lower portion 80b of the magazine 80. The claw engagement portion 80e is pin-shaped extending in the left-right direction and releasably engages the claws 81e. The claws 81e engages the claw engagement portion 80e, thereby holding the pusher 81 at the lowest position.

As shown in FIG. 1, a recess 11h is formed in the left portion of the lower housing 11d. The height of the upper end of the recess 11h is lower than the right portion of the lower housing 11d that connects to the motor housing 12. The recess 11h is disposed rearward of the magazine 80. As shown in FIG. 3, the upper end surface of the recess 11h is substantially horizontal and lower than the pusher surface 81a of the pusher 81 when the pusher 81 is at its lowest position. This configuration creates a space for loading the driving members N into the magazine 80 at the rear of the magazine 80 and above the recess 11h. While the pusher 81 is being held at its lowest position, a plurality of driving members N can be loaded from the rear end of the magazine 80 toward the front. After the driving members N are placed on the pusher surface 81a, the engagement between the claw 81e and the claw engagement portion 80e is released (see FIG. 8). As a result, the driving members are loaded into the magazine 80 by being pushed upward by the pusher 81.

As shown in FIG. 3, a release lever 80f is on the left side of the lower portion 80b of the magazine 80. When the user moves the magazine 80 forward and downward while pressing the release lever 80f, the lower portion 80b of the magazine 80 can be removed from the lower housing 11d. When attaching the lower portion 80b of the magazine 80 to the lower housing 11d, the magazine 80 can be automatically attached by bringing the lower portion 80b of the magazine 80 toward the lower housing 11d in a rearward and upward direction without pressing the release lever 80f.

Next, a series of driving operations of the driving tool 1 will be described with reference to FIGS. 1 to 20. In the standby position, the driver 24 is stopped slightly before the top dead center (see FIG. 8). When the driver 24 is in the standby position, the bottom surface of the foremost rack tooth 24a engages the last engaging pin 63b. The contact arm 3 moves rearward when pressed against the workpiece W. The adjuster 6 moves rearward together with the contact arm 3 and presses the switch 6c. The switch 6c transmits an on signal to the controller 35. The controller 35 activates the electric motor 30 when it receives the on signal from the switch 6c and the trigger 5 is pressed rearward. When the electric motor 30 is activated, the wheel 62 of the lifter 60 rotates. The last engaging pin 63b moves the foremost rack tooth 24a in the rearward direction. Due to this movement, the driver 24 moves rearward from the standby position to the top dead center.

When the driver 24 is stopped at the standby position, the tip end 24b of the driver 24 overlaps the head Na of the driving member N, which is closest to the driving passage 2a, in the front-rear direction. Therefore, no driving member N is loaded in the driving passage 2a. When the tip end 24b of the driver 24 moves rearward relative to the head Na of the driving member N, the uppermost driving member N is loaded into the driving passage 2a. When the driver 24 moves to the top dead center immediately before driving of the driving member N, the last engaging pin 63b moves upward to disengage from the bottom surface of the foremost rack tooth 24a. Then, the driver 24 moves forward due to the gas pressure in the accumulation chamber 22 that has acted on the piston 23. The tip end 24b of the driver 24 strikes (drives) the driving member N in the driving passage 2a in the forward direction. The driving member N, driven by the driver 24, is ejected from the ejection port 2b into the workpiece W.

The wheel 62 continues to rotate while the driver 24 is moving forward and after it has reached the bottom dead center. After the driver 24 has reached the bottom dead center, the first engaging pin 63a engages the bottom surface of the rearmost rack tooth 24a when the wheel 62 rotates to a predetermined rotation angle. Due to this movement, a return operation is initiated to move the driver 24 to its rear standby position. When the last engaging pin 63b engages the bottom surface of the foremost rack tooth 24a, the driver 24 returns to the standby position. For example, by appropriately measuring the time from the start of the electric motor 30 or by appropriately measuring the rotational position of the wheel 62, the electric motor 30 is stopped when the piston 23 reaches the standby position. As a result, the driver 24 is held at the standby position, thereby completing the series of driving operations.

As described above and shown in FIGS. 4, 7, 11, and 12, the driving tool 1 includes the driving mechanism 20, the power transmission mechanism 40, and the mechanism housing (gear housing 14 and lifter housing 15). The driving mechanism 20 biases the driver 24 forward. The power transmission mechanism 40 moves the driver 24 rearward by the output of the electric motor 30. The gear housing 14 and the lifter housing 15 house the power transmission mechanism 40. The driving tool 1 includes the motor housing 12, the fastening portion 12b, and the main body housing 11. The motor housing 12 houses the electric motor 30. The fastening portion 12b fastens (secures) the motor housing 12 to the gear housing 14 with screws (fasteners). The main body housing 11 is configured to enclose the gear housing 14 and the lifter housing 15, while leaving the motor housing 12 exposed.

According to this configuration, the gear housing 14, which rotatably supports the motor shaft 30a and the rotor 30b, and the motor housing 12, which supports the stator 30c, are fastened with screws (fasteners). Accordingly, the motor housing 12 is configured to follow the vibration generated by the power transmission mechanism 40 inside the gear housing 14 or the lifter housing 15. More specifically, the vibration transmitted from the gear housing 14 to the rotor 30b and the vibration transmitted from the gear housing 14 to the stator 30c via the motor housing 12 occur in the same vibration mode. This mechanism mitigates contact between the rotor 30b and the stator 30c by vibration transmission. Accordingly, contact between the rotor 30b and the stator 30c of the electric motor 30 is effectively suppressed, thereby preventing core rubbing.

In addition, by exposing the motor housing 12 from the main body housing 11, the size of the motor housing 12 can be reduced. As a result, the design flexibility of structures near the motor housing 12, such as the magazine 80 and the handle 4, is enhanced, enabling a more compact configuration of the entire driving tool 1.

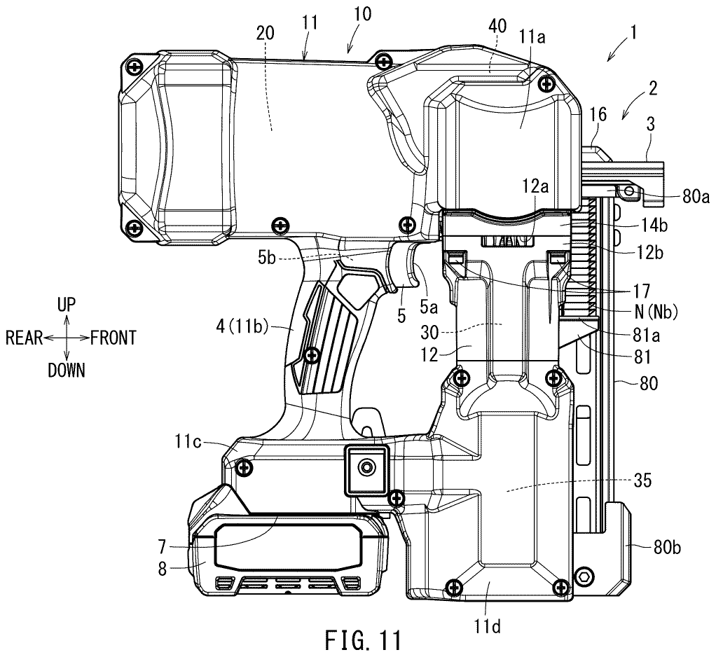

As shown in FIGS. 4 and 11, the motor housing 12 is formed in a tubular shaper. The tubular fastened portion 14b of the gear housing 14, to which the fastening portion 12b is fastened with screws (fasteners), is exposed (and away) from the main body housing 11. Therefore, vibration can be further suppressed from being transmitted from the gear housing 14 to the motor housing 12 via the main body housing 11. In addition, the compactness around the motor housing 12 can be further improved. Furthermore, by fastening the tubular motor housing 12 to the tubular fastened portion 14b, the overall structure can be made more compact while maintaining the airtightness and rigidity between the motor housing 12 and the gear housing 14 at levels comparable to the conventional designs.

As shown in FIGS. 11 and 12, the main body housing 11 includes the upper housing 11a, the handle housing 11b, and the lower housing 11d. The upper housing 11a houses the gear housing 14 and the lifter housing 15. The handle housing 11b extends downward from the upper housing 11a and supports the handle 4. The lower housing 11d protrudes forward from the lower portion of the handle housing 11b and connects to the lower portion of the motor housing 12.

For example, a case is considered where vibration is transmitted from the gear housing 14 or the lifter housing 15 to the lower portion of the motor housing 12 via the main body housing 11. The transmission path of the vibration involves the upper housing 11a, the handle housing 11b, and the lower housing 11d. The main body housing 11 is made of a material with lower rigidity than the motor housing 12. If vibration is transmitted through this transmission path, the handle housing 11b mainly deflects. Therefore, the vibration is reduced before transmitted to the lower housing 11d. As a result, vibration transmitted to the motor housing 12 via the main body housing 11 can be effectively suppressed. Accordingly, vibration transmitted to the motor housing 12 from components other than the gear housing 14 can be effectively suppressed. As a result, the vibration modes of the rotor 30b and the stator 30c can be better aligned, thereby suppressing core rubbing.

As shown in FIGS. 5 and 6, the rubber ring (elastic member) 18 is placed between the upper housing 11a and the gear housing 14 or the lifter housing 15. Therefore, by absorbing vibrations with the rubber ring 18, vibrations transmitted from the gear housing 14 or the lifter housing 15 to the upper housing 11a can be efficiently reduced.

As shown in FIGS. 12 and 13, the elastic member 18 is a rubber ring that is held in an elastically deformed state between the inner surface of the upper housing 11a and the outer surface of the gear housing 14 or the lifter housing 15. Therefore, the upper housing 11a and the gear housing 14 or lifter housing 15 are connected with the rubber ring clamped between them over a wide range corresponding to the diameter of the rubber ring. As a result, the vibration transmitted from the gear housing 14 or the lifter housing 15 to the main body housing 11 can be effectively reduced while improving the stability with which the main body housing 11 holds the gear housing 14 and the lifter housing 15.

As shown in FIGS. 12 and 13, the lower housing 11d includes the connecting portion 11g. The connecting portion 11g connects to the lower portion of the motor housing 12 and positions the lower portion (connected portion 12c) of the motor housing 12. Therefore, the lower portion of the motor housing 12 and the connecting portion 11g of the lower housing 11d are connected and positioned relative to each other without placing, for example, an elastic member. Therefore, the motor housing 12 is fastened to the gear housing 14 with screws (fasteners) at the upper portion, and is connected to the lower housing 11d at the lower portion and positioned in the up-down direction. As a result, the motor housing 12 can be held in a stable manner.

As shown in FIGS. 5 and 12, the controller 35 that controls the motor 30 is arranged in the lower housing 11d. Therefore, by arranging the controller 35 in the vicinity of the motor 30, wirings connecting the controller 35 and the motor 30 can be made compact. Moreover, the controller 35 can be compactly arranged by utilizing the space below the motor 30.

As shown in FIG. 5, the driving tool 1 has the fan 31, the ventilation hole 11i, and the air passage S. The fan 31 rotates by driving of the electric motor 30. The ventilation hole 11i is disposed in the lower portion of the lower housing 11d. The air passage S introduces outside air, taken in by the suction force of the fan 31 from the ventilation hole 11i, into the motor housing 12 from inside the lower housing 11d. Therefore, the controller 35 can also be cooled using the cooling air that cools the electric motor 30. In addition, by designing the air passage S with a simple route that minimizes detours, the cooling air flow can maintain its momentum from the ventilation hole 11i to the exhaustion hole 12a.

As shown in FIGS. 5 and 12, the controller 35 is rectangular and is housed in the lower housing 11d in a position in which its longitudinal direction extends in the up-down direction. Outside air from the ventilation hole 11i flows along the longitudinal direction of the controller 35. Therefore, the controller 35 can be efficiently cooled by flowing the cooling air along the longitudinal direction of the controller 35.

As shown in FIGS. 4 and 11, the magazine 80 that houses a plurality of driving members N is provided. The upper portion 80a of the magazine 80 connects to the gear housing 14 and the lifter housing 15. The lower portion 80b of the magazine 80 connects to the lower housing 11d. That is, the magazine 80 connects to the gear housing 14 and the lifter housing 15 at the upper portion 80a and connects to the lower housing 11d at the lower portion 80b, thereby positioning the magazine 80 in the up-down direction. As a result of this configuration, the magazine 80 can be held with improved stability.

As shown in FIGS. 2, 7, and 8, the driving tool 1 has a driver 24, a handle 4, and a magazine 80. The driver 24 moves forward with the piston 23 due to the gas pressure within the cylinder 21. The handle 4 extends downward from the tool main body 10, which houses the driver 24. The magazine 80 houses the driving members N and extends downward from the tool main body 10 located forward of the handle 4. The driving tool 1 also has the motor housing 12 and the lifter 60. The motor housing 12 extends downward from the tool main body 10 on one side of the magazine 80 in the left-right direction. It is arranged adjacent to the magazine 80 in the left-right direction and overlaps with the magazine 80 in the front-rear direction. The lifter 60 is rotated by the electric motor 30 housed in the motor housing 12 to move the driver 24 rearward. The lifter 60 is positioned above the driver 24. The operating surface 5a of the trigger 5, which is movably arranged on the handle 4 and pressed by the user, is positioned forward of the rear end of the lifter 60. Alternatively, the operating surface 5a is positioned forward of the front end 25a, which is arranged on the cylinder 21 to absorb the forward impact of the piston 23.

Therefore, the motor housing 12 is disposed in a position offset to the right from the area between the handle 4 and the magazine 80 in the front-rear direction (see FIG. 10). The lifter 60 is arranged above the driver 24, i.e., on the opposite side of the handle 4 and the magazine 80 with respect to the driver 24. Therefore, the lifter 60 and the power transmission mechanism 40 from the electric motor 30 to the lifter 60 can be disposed away from the area between the handle 4 and the magazine 80 in the front-rear direction. As a result, the magazine 80, which accounts for a major portion of the weight of the driving tool 1, can be arranged closer to the handle 4.

One condition for determining that the magazine 80 and the handle 4 are close to each other in the front-rear direction is that the operating surface 5a of the trigger 5 arranged on the handle 4 is located forward of the rear end of the lifter 60 that includes the lifter housing 15. Another condition is that the operating surface 5a of the trigger 5 is located forward of the front end 25a of the damper 25 in the cylinder 21. By satisfying either condition, the distance between the magazine 80 and the handle 4 in the front-rear direction can be shortened such that the handle 4 is closer to the center of gravity of the driving tool 1. This improves the handling performance of the driving tool 1.

As shown in FIGS. 4 and 5, the motor housing 12 is positioned offset to one side of the trigger 5 in the left-right direction. Therefore, by arranging the motor housing 12 away from the trigger 5 in the left-right direction, it becomes easy to shorten the distance between the magazine 80 and the handle 4 in the front-rear direction. This, in turn, facilitates arranging the handle 4 closer to the center of gravity of the driving tool 1.

As shown in FIGS. 4 and 5, there is a space A between the motor housing 12 and the handle 4 in the left-right direction when viewed from the front. Therefore, by separating the motor housing 12 and the handle 4 in the left-right direction, it becomes easy to shorten the distance between the magazine 80 and the handle 4 in the front-rear direction. This, in turn, facilitates arranging the handle 4 closer to the center of gravity of the driving tool 1.

As shown in FIGS. 7 and 13, the air chamber 22a is arranged. The air chamber 22a communicates with the rear of the cylinder 21 and is disposed behind the lifter 60. Therefore, the air chamber 22a can be arranged by using the space behind the lifter 60 disposed above the driver 24. This makes it possible to provide a large-capacity air chamber 22a while suppressing an increase in the size of the tool main body 10 of the driving tool 1.

As shown in FIGS. 4 and 5, the magazine 80 extends from the tool main body 10 in a direction substantially parallel to the handle 4 when viewed from the front and rear. Therefore, the handle 4 and the magazine 80 can be compactly arranged not only in the front-rear direction but also in the left-right direction. Accordingly, the overall structure of the driving tool 1 can be compactly arranged.

As shown in FIG. 8, the magazine 80 is constructed such the driving members N (staples) are loaded from the rear to the front. Therefore, by offsetting the motor housing 12 in the left-right direction with respect to the magazine 80, a space for loading driving members N can be provided at the rear of the magazine 80. Moreover, the staples are loaded from the rear to the front in a posture where the heads Na is positioned at the rear and a pair of legs Na extend forward, such that the magazine 80 is held (sandwiched) between the pair of legs Nb. Thus, the driving members N can be quickly loaded into the magazine 80 without the need for opening and closing a loading port, etc., or removing a holding section for holding the driving member N from the magazine 80.

As shown in FIGS. 5 and 12A, the controller 35 that drives the electric motor 30 in conjunction with the trigger 5 is arranged such that the controller 35 overlaps the magazine 80 when viewed from the left or right side. Therefore, the controller 35 can be placed in the space on one side of the magazine 80 in the left-right direction and below the motor housing 12. This allows the controller 35 to be placed near the motor 30 while shortening the distance between the magazine 80 and the handle 4 in the front-rear direction.

As shown in FIGS. 5, 6, and 14, the driving tool 1 has the speed reduction mechanism 41. The speed reduction mechanism 41 reduces the output of the electric motor 30 and transmits it to the lifter 60. The upstream speed reduction section 41a in which the driving bevel gear 42 engages the driven bevel gear 44 is arranged at the uppermost end of the speed reduction mechanism 41. Therefore, the upstream speed reduction section 41a at the uppermost end of the speed reduction mechanism 41 is arranged above the motor 30 on the downstream side of the motor 30. In addition, by arranging the upstream speed reduction section 41a, the motor shaft 30a and the lifter shaft 61 are substantially perpendicular to each other. This allows the motor housing 12 to be positioned on one side of the magazine 80 in the left-right direction and arranged adjacent to the magazine in the left-right direction overlapping with the magazine 80 in the-down direction, while the motor shaft 30a extends in the up-down direction. In addition, the lifter 60 can be positioned above the driver 24. By arranging the motor housing 12 and the lifter 60 appropriately, the front-rear spacing between the magazine 80 and the handle 4 can be reduced.

As shown in FIG. 5, the motor shaft 30a of the motor 30 is located between the follower bevel gear 44 and the lifter 60 in the left-right direction. Therefore, while the motor housing 12 is disposed at a position away from the area between the handle 4 and the magazine 80 in the front-rear direction, the motor shaft 30a can be arranged closer to the lifter 60 in the left-right direction. This makes it possible to suppress enlargement of the entire driving tool 1 in the left-right direction.

As shown in FIG. 2 and FIG. 11, the motor housing 12 is exposed from the main body housing 11 of the tool main body 10. Therefore, the area around the motor housing 12 can be made compact. As a result, the motor housing 12 can be disposed in a position away from the area between the handle 4 and the magazine 80 in the front-rear direction, while suppressing enlargement of the entire driving tool 1 in the left-right direction.

Various changes can be made to the driving tool 1 of the present embodiment described above. A gas spring-type driving tool is illustrated as an example of the driving tool 1. Instead, the present disclosure may be applied to a mechanical spring-type driving tool. A staple is illustrated as an example of the driving members N. Instead, the present disclosure may be applied to a driving tool in which nails are driven as the driving members N.

In the above embodiment, the lifter 60 that is arranged above the driver 24 is illustrated. The bevel gears 42, 44 and the spur gears 45, 51 are arranged in the speed reduction mechanism 41 between the electric motor 30 and the lifter 60. Instead, the lifter 60 may be disposed on either the left or right side of the driver 24. The speed reduction mechanism 41 may be a planetary speed reduction mechanism.

In the embodiment, the motor housing 12 is disposed on the right side of the magazine 80. Instead, the motor housing 12 may be disposed on the left side of the magazine 80. In the embodiment, the magazine 80 extends straight downward from the driving nose 2. Instead, the magazine 80 may be inclined in the left-right direction toward the bottom.

In the embodiment, the motor housing 12 is clamped between the left and right half-split lower housing 11d and connected thereto. Instead, the lower housing 11d and the motor housing 12 may be directly screwed together. In the embodiment, the exhaust hole 12a penetrates the motor housing 12. Instead, the exhaust hole 12a may be provided in the fastened portion 14b of the gear housing 14.

In the embodiment, the controller 35 is housed in the lower housing 11d below the motor housing 12 with its longitudinal direction in the up-down direction. However, an orientation of the controller 35 are not limited to the illustrated embodiment, and may be changed as appropriate. For example, the longitudinal direction of the controller 35 may be inclined in the front-rear direction or in the up-down direction.

In the embodiment, the rubber ring 18 is placed between the inner surface of the upper housing 11a and the outer surface of the mechanism housing. However, the position and number of rubber rings 18 may be changed as appropriate and are not limited to the illustrated positions. In addition, a spring may be placed instead of the rubber rings 18.

In the embodiment, the speed reduction mechanism 41 that reduces speed in two stages, i.e. the upstream speed reduction section 41a and the downstream speed reduction section 41b. The upstream speed reduction section 41a includes the bevel gears engaging with each other, and the downstream speed reduction section 41b includes the spur gears engaging with each other. However, the number of reduction stages, the types of gears, the order, etc. are not limited to the illustrated embodiment and may be changed as appropriate. For example, only one reduction stage or three or more reduction stages may be used. Instead of the engagement between the spur gears, an engagement between helical gears may be used in the reduction portion. For example, the upstream speed reduction portion may be an engagement between spur gears or helical gears, and the downstream speed reduction portion may be an engagement between bevel gears. Furthermore, in case of the three-stage reduction, the first stage may be a bevel gear engagement, and the second and third stages may be a spur gear engagement or a helical gear engagement. Alternatively, the first and third stages may be a spur gear engagement or a helical gear engagement, and the second stage may be a bevel gear engagement.

In the embodiment, the stopper 70 is positioned on the outer circumference of the intermediate shaft 43. Specifically, the stopper 70 is located on the downstream side of the driven bevel gear 44 and on the upstream side of the driving spur gear 45. However, the position of the stopper 70 is not limited to this location. The stopper 70 may be positioned on the outer circumference of the lifter shaft 61. Alternatively, a drive spur gear or a drive helical gear may be arranged on the downstream end of the motor shaft 30a, and the stopper 70 may be positioned on the outer circumference of the motor shaft 30a. Furthermore, if the speed reduction mechanism utilizes three or more stages, the stopper 70 may be positioned on the outer circumference of any of the rotation members on the downstream side of the driven bevel gear.

In the embodiment, the stopper 70 has six wedge grooves 73 and six wedge members 74. However, the number of wedge grooves 73 and wedge members 74 is not limited and may be changed as appropriate. In the embodiment, the wedge groove 73 are formed on the outer circumferential surface 72a of the inner ring 72. Instead, the wedge groove 73 may be formed radially outward on the inner circumferential surface 71c of the outer ring 71 in a recessed manner.

In the embodiment, the buffering mechanism 50 is provided in the outer circumference of the lifter shaft 61 and includes the follower spur gear 51. However, the position and configuration of the buffering mechanism 50 are not limited and may be changed as appropriate. For example, the upstream rotating member may not serve as a reduction gear, and the buffering mechanism 50 may be arranged on the downstream side of the follower spur gear 51. Furthermore, the buffering mechanism 50 may be arranged upstream of the downstream speed reduction gear, for example, in the outer circumference of the intermediate shaft 43.

In the embodiment, the lifter shaft 61 and the driving ring 52 are rotatably connected as a unit via the balls 54. Alternatively, the lifter shaft 61 and the driving ring 52 may be rotatably connected as a unit, for example, by means of a spline shaft engagement. In the engagement, the hemispherical ball hole 61d is arranged in the lifter shaft 61 and the ball groove 52f extending in the axial direction is arranged in the driving ring 52. Alternatively, ball grooves extending in the axial direction may be arranged in both the lifter shaft 61 and the driving ring 52, and the balls 54 may be positioned in the axial direction at the bottom of the ball grooves. In the embodiment, the buffering mechanism 50 has three buffering members 53. However, the number of buffering members 53 is not limited and may be changed as appropriate.

We claim:

1. A driving tool comprising:
a driving mechanism configured to bias a driver in a forward direction;
a power transmission mechanism configured to move the driver in a rearward direction using an output from an electric motor;
a mechanism housing that houses the power transmission mechanism;
a motor housing that houses the electric motor;
a fastening portion that fastens the motor housing to the mechanism housing using a fastener; and
a main body housing configured to enclose the mechanism housing while leaving the motor housing exposed.

2. The driving tool according to claim 1, wherein
the motor housing is formed in a tubular shape,
the mechanism housing includes a tubular fastened portion configured to be fastened to the fastening portion with a fastener, and
the tubular fastened portion is exposed from the main body housing.

3. The driving tool according to claim 1, wherein the main body housing further comprises:
an upper housing that houses the mechanism housing;
a handle housing that extends downward from the upper housing and supports a handle; and
a lower housing that protrudes forward from a lower portion of the handle housing and is configured to connect to a lower portion of the motor housing.

4. The driving tool according to claim 3, further comprising an elastic member that is placed between the upper housing and the mechanism housing.

5. The driving tool according to claim 4, wherein the elastic member is a rubber ring that is held in an elastically deformed state between an outer surface of the mechanism housing and an inner surface of the upper housing.

6. The driving tool according to claim 3, wherein the lower housing includes a connecting portion that connects to a lower portion of the motor housing, thereby positioning the lower portion of the motor housing.

7. The driving tool according to claim 3, further comprising a controller,
wherein the controller is housed in the lower housing.

8. The driving tool according to claim 7, further comprising:
a fan configured to rotate by the electric motor;
a ventilation hole located in a lower portion of the lower housing; and
an air passage configured to introduce outside air, which is taken in through the ventilation hole by suction force of the fan, into the motor housing from inside the lower housing.

9. The driving tool according to claim 8, further comprising a magazine that houses a plurality of driving members and extends in a front-rear direction and in an up-down direction, wherein
the controller is rectangular and housed in the lower housing in a manner such that a wide surface of the controller extends in a longitudinal direction of the controller and is aligned with the magazine, and
the outside air from the ventilation hole flows between an inner surface of the lower housing and the wide surface of the controller along the longitudinal direction of the controller.

10. The driving tool according to claim 3, further comprising a magazine that houses a plurality of driving members, wherein
an upper portion of the magazine connects to the mechanism housing, and
a lower portion of the magazine connects to a lower housing.

11. The driving tool according to claim 6, wherein the connecting portion includes a rib arranged on an inner surface of an upper portion of the lower housing and extending in a circumferential direction.

12. The driving tool according to claim 11, wherein
the motor housing includes a circumferential groove formed on an outer surface of a lower portion of the motor housing, and
the motor housing is configured to be positioned relative to the lower housing via engagement between the rib and the groove.

13. The driving tool according to claim 10, wherein the mechanism housing includes a driver guide that extends in a front-rear direction and connects to the upper portion of the magazine.

14. A driving tool comprising:
a driving mechanism configured to move a driver in a driving direction;
a power transmission mechanism including a lifter configured to move the driver in a direction opposite to the driving direction, and a reduction mechanism configured to reduce an output of an electric motor and transmits the reduced output to the lifter;
a mechanism housing configured to house the power transmission mechanism;
a motor housing formed in a tubular shape and configured to house the electric motor;
a fastening portion formed on the motor housing; and
a main body housing configured to enclose the mechanism housing,
wherein the motor housing is configured to be fastened to the mechanism housing with screws through the fastening portion, and is exposed outside the mechanism housing.

15. The driving tool according to claim 14, further comprising a tubular fastened portion that is formed in the mechanism housing and configured to fasten the fastening portion with a fastener,
wherein the tubular fastened portion is exposed from the main body housing.

16. The driving tool according to claim 15, further comprising a gear housing that houses the reduction mechanism,
wherein the gear housing includes the tubular fastened portion.

17. The driving tool according to claim 16, further comprising a lifter housing that houses the lifter,
wherein the mechanism housing includes the lifter housing and the gear housing.

18. The driving tool according to claim 17, wherein
the main body housing has a half-split structure and includes an upper housing, a handle housing, and a lower housing,
the upper housing houses the mechanism housing,
the handle housing extends downward from the upper housing and supports the handle, and
the lower housing protrudes forward from a lower portion of the handle housing and is configured to connect to a lower portion of the motor housing.

19. The driving tool according to claim 18, wherein
a first elastic member is positioned between the gear housing and one of left and right half-split upper housings, and
a second elastic member is positioned between the lifter housing and the other of the left and right half-split upper housings.

20. The driving tool according claim 14, wherein the driving mechanism includes a piston configured to move integrally with the driver, and an accumulation chamber configured to be pressurized by a rearward movement of the piston.
